(19) United States
(12) Patent Application Publication
(10) Pub. No.: US 2021/0198512 A1
(43) Pub. Date: Jul. 1, 2021

(54) AQUEOUS INKJET INK AND INK SET

(71) Applicant: RISO KAGAKU CORPORATION, Tokyo (JP)

(72) Inventors: Sayako NAKAO, Ibaraki (JP); Hajime TSUNODA, Ibaraki (JP); Yuki URANO, Ibaraki (JP); Hideki IMANISHI, Ibaraki (JP); Hiroaki GAU, Ibaraki (JP)

(21) Appl. No.: 17/131,199

(22) Filed: Dec. 22, 2020

(30) Foreign Application Priority Data
Dec. 27, 2019 (JP) 2019-237947
Oct. 30, 2020 (JP) 2020-182574

(51) Int. Cl. C09D 11/54; C09D 11/322; C09D 11/107; C09D 11/102

(52) U.S. Cl. CPC C09D 11/54; C09D 11/102; C09D 11/107; C09D 11/322

(57) ABSTRACT

An aqueous inkjet ink is disclosed that contains a water-dispersible polyether-type aliphatic urethane-based resin (A), a water-dispersible (meth)acrylic-based resin (B), a surfactant containing an acetylene glycol-based surfactant (C) having an HLB value of not more than 10.0, a colorant, and water. An ink set is also disclosed.

### CROSS REFERENCE TO RELATED APPLICATIONS

This application is based upon and claims the benefit of priority from the prior Japanese Patent Application No. 2019-237947, filed on Dec. 27, 2019, the entire contents of which are incorporated by reference herein, and the prior Japanese Patent Application No. 2020-182574, filed on Oct. 30, 2020, the entire contents of which are incorporated by reference herein.

### BACKGROUND OF THE INVENTION

### Field of the Invention

The present invention relates to an aqueous inkjet ink and an ink set.

### Description of the Related Art

The ink jet recording system is a printing system in which a liquid ink having high fluidity is jetted from fine nozzles and is adhered to a substrate, thereby performing printing. Since this system enables high-speed printing of high-resolution and high-quality images to be conducted with little noise using a relatively inexpensive device, it has rapidly become widespread in recent years.

In terms of inks, aqueous-type inks have become widespread, since they enable printing of high quality images at low cost. Aqueous inks have improved drying properties by containing water, and also have an advantage of excellent environmental friendliness.

In recent years, the inkjet recording system has been used not only for paper media such as plain paper and special purpose paper, but also for woven fabrics, nonwoven fabrics such as felt, and wooden materials, in which ink bleeding may be easily caused along with fibers. The inkjet recording system has also been used for functional porous materials in which the functions are expressed by the voids of the substrates, and has also been used for substrates which are poorly permeable to inks, such as plastic substrates, synthetic papers, metal substrates, and glass substrates, and the like. In order to perform high-quality printing on such a variety of substrates, high image quality is required, and, for substrates used for various building materials, furniture, daily necessaries, and the like, in addition to high image quality, high durability is also required.

There is a method for imparting durability to a printed matter by coating an overcoat layer containing a highly durable resin after forming a printed image (JP 2013-163370 A (also referred to as Patent Document 1)).

JP 2008-149584 A (also referred to as Patent Document 2) discloses a coated metal plate in which a hue coating film, a printing layer, and a clear coating film are provided on a metal plate, and the clear coating film contains a specific polyester resin.

Since substrates used for building materials, furniture, daily necessaries, and the like are more expensive than general papers, and may sometimes have a very large area, the occurrence of defective products due to poor jetting during inkjet printing may greatly affect the costs. Therefore, for the printing on the substrates used for building materials, furniture and daily necessaries, a higher jetting reliability than that of general printing methods in which paper or the like is used as a substrate is desirable.

In order to suppress jetting faults in inkjet printing, printers are usually provided with a maintenance mechanism. In particular, inks may sometimes gradually adhere to the vicinity of nozzles of the inkjet head during continuous printing. When ink stains in the vicinity of the nozzles become remarkable, straight flying of the ink from the nozzles may sometimes be affected. In addition or alternatively, when the ink stains in the vicinity of the nozzles become remarkable, foreign matter may sometimes adhere to the ink stains and get into the interior of the head from the nozzles, resulting in nozzle blockage.

As to the maintenance, there is a method of wiping off the ink adhered to the nozzle surface. However, when the nozzle surface is wiped off using a dry member, the nozzle plate may sometimes be damaged, and, therefore, there is a method of wiping off using a cleaning liquid. JP 2009-233911 A (also referred to as Patent Document 3) proposes an inkjet head cleaning liquid containing a solvent having a surface tension of less than 35 mN/m and a basic compound, as a cleaning liquid for aqueous pigment ink jet printers.

### SUMMARY OF THE INVENTION

One aspect of the invention provides an aqueous inkjet ink containing a water-dispersible polyether-type aliphatic urethane-based resin (A), a water-dispersible (meth)acrylic-based resin (B), an acetylene glycol-based surfactant (C) having an HLB value of not more than 10.0, a colorant, and water.

Another aspect of the present invention provides an ink set including the aqueous inkjet ink as described above, and a maintenance liquid containing an acetylene glycol-based surfactant (C′) having an HLB value of not more than 10.0, and at least 30% by mass, relative to the total mass of the maintenance liquid, of glycerol.

### DETAILED DESCRIPTION OF THE EMBODIMENTS

The method of providing an overcoat layer is an effective method; however, in those cases where the strength of the ink coating film itself is low and the durability thereof is low, the amount of resin contained in the overcoat layer becomes very large. As a result, a considerably thick resin film is formed on the substrate, and because of this, the texture inherently possessed by the substrate may be impaired. Further, when a functional substrate is used, an excessively thick overcoat layer may deteriorate the function inherently possessed by the functional substrate.

It is desirable that the ink coating film on the substrate has flexibility. When using a deformable substrate such as a paper medium, a woven fabric, or a nonwoven fabric, it is desirable that the ink coating film deforms in accordance with the deformation of the substrate, so that no cracks occur in the ink coating film. In some applications, the printing portion of the substrate is subjected to processing such as bending, and, in such applications, it is also desirable to ensure the image quality of the processed portion. In those cases in which the portion provided with an overcoat layer is subjected to bending, the resin film may sometimes be cracked due to a large amount of resin, and a so-called whitening phenomenon may be observed.

Since aqueous inks are excellent in environmental friendliness, they are expected to be applied to various kinds of substrates. However, in the technology in which a resin component is added to an aqueous ink and the resin component in the aqueous ink is formed into a coating film on the substrate, it is desirable to appropriately control the resin dispersibility in water, the resin spreadability on the substrate and the like, and further improvement is desired.

With respect to the cleaning liquid proposed in Patent Document 3, the basic compound contained in the cleaning liquid may sometimes be effective in redissolving or redispersing an acid component-containing resin used in the ink; however, depending on the combination with the resin or the amount of use, the stability may be lowered when the cleaning liquid is mixed with the ink, and contamination may occur in the vicinity of the nozzles with the thickened mixed liquid or generated foreign matter, resulting in impaired jetting reliability such as poor image uniformity and poor continuous jetting performance. The combination of the maintenance liquid and the ink may also be an issue to be studied, and it is desired that favorable cleaning efficiency can be exhibited even in a state where the maintenance liquid is mixed with the ink, for example, in a state where the maintenance liquid is concentrated due to drying.

An object of the present invention is to provide an aqueous inkjet ink with which a printed matter with a printed image having excellent durability and workability can be formed.

Embodiments of the present invention are described below. However, the examples in the following embodiments in no way limit the present invention.

[Aqueous Inkjet Ink]

An aqueous inkjet ink according to one of embodiments (hereafter sometimes referred to as simply “the ink” or “the aqueous ink”) contains a water-dispersible polyether-type aliphatic urethane-based resin (A), a water-dispersible (meth)acrylic-based resin (B), an acetylene glycol-based surfactant (C) having an HLB value of not more than 10.0, a colorant, and water.

According to one embodiment, a printed matter with a printed image having excellent durability and workability can be provided. Further, according to one embodiment, a printed matter with a printed image having excellent image quality can be provided.

In the following description, the water-dispersible polyether-type aliphatic urethane-based resin (A) is also referred to as the urethane-based resin (A), the water-dispersible (meth)acrylic-based resin is also referred to as the (meth)acrylic-based resin (B), and the acetylene glycol-based surfactant (C) having an HLB value of not more than 10.0 is also referred to as the surfactant (C).

An ink according to one embodiment contains a polyether-type aliphatic urethane-based resin (A) having flexibility and a (meth)acrylic-based resin (B) having hardness in combination, and further contains an acetylene glycol-based surfactant (C) having a low HLB value, which has high wettability and may easily cause swelling of the urethane-based resin (A) in the ink. This may enable an ink coating film that uniformly covers the substrate and that has excellent durability and workability to be formed after printing and drying. Due to the excellent durability and workability of the ink coating film, the occurrence of cracks or whitening phenomena in the processed portion can be suppressed even when processing such as bending is performed after the ink coating film is formed. Further, the durability of the ink coating film after processing can be enhanced.

One of the reasons therefore is described below, which, however, in no way limits the present invention.

According to one embodiment, the ink contains both a polyether-type aliphatic urethane-based resin (A) having flexibility and a (meth)acrylic-based resin (B) having hardness. This may enable the durability and the workability of the ink coating film to be enhanced.

By ensuring that the ink contains the urethane-based resin (A), and also contains the surfactant (C) having a low HLB value, which functions to cause swelling of the urethane-based resin (A), when the applied ink is dried and formed into an ink coating film after printing, the surfactant (C) is concentrated while water is evaporated on the substrate, and swelling of the urethane-based resin (A) can be advanced to facilitate film formation. As a result, a stronger ink coating film can be formed, and thus, the durability of the ink coating film can be enhanced. With the use of the urethane-based resin (A) having flexibility, the workability of the ink coating film can be enhanced. An acetylene glycol-based surfactant having a low HLB value of not more than 10.0 can preferably be used as the surfactant which may easily cause swelling of the polyether-type aliphatic urethane-based resin (A).

The polyether-type aliphatic urethane-based resin (A) may impart durability and workability to the ink coating film in a well-balanced manner. The urethane-based resin (A) may prevent yellowing and deterioration of the ink coating film, thereby enabling the formation of an ink coating film of higher image quality.

The ink according to one embodiment may contain a water-dispersible polyether-type aliphatic urethane-based resin (A).

Since the urethane-based resin (A) exhibits water dispersibility, the urethane-based resin (A) is able to be dispersed in water in particulate form without dissolving, thus forming an oil-in-water (O/W) resin emulsion. The urethane-based resin (A) is preferably contained in the ink in a dispersed state as resin particles.

The urethane-based resin (A) may be any of an anionic resin, a cationic resin, an amphoteric resin, and a nonionic resin. From the viewpoint of the stability of the colorant in water, an anionic resin, an amphoteric resin and/or a nonionic resin can be preferably used, since, in many of colorants suitable for aqueous inks, the surface charge of the colorant dispersed in water is anionic.

The water-dispersible urethane-based resin (A) may be a resin in which functional groups of the resin exist at the particle surfaces, such as a self-emulsifying resin. The water-dispersible urethane-based resin (A) may be a resin that has been subjected to a surface treatment such as adhering a dispersant to the surface of the resin particles.

The urethane-based resin (A) is preferably a polyether-type aliphatic urethane-based resin that has an aliphatic urethane skeleton and contains an ether linkage in the main chain in addition to the aliphatic urethane skeleton.

As the urethane-based resin (A), a reaction product of an aliphatic polyisocyanate and a polyether polyol can be used.

As the aliphatic polyisocyanate, an aliphatic polyisocyanate compound having two or more isocyanate groups in one molecule, preferably an aliphatic diisocyanate, can be used.

By ensuring that, in the urethane-based resin (A), the urethane skeleton portion contains an aliphatic urethane skeleton, and contained more preferably a chain-like urethane skeleton owing to an aliphatic diisocyanate, the strength of the ink coating film can be further enhanced, and the flexibility of the ink coating film can also be further enhanced. As a result, the durability of the ink coating film can be further enhanced and the workability of the ink coating film can also be further enhanced.

In those cases where the urethane-based resin (A) synthesized using an aliphatic polyisocyanate is used, yellowing of the urethane-based resin itself can be prevented, whereby a resin film having improved transparency can be formed. Accordingly, the color development of the aqueous ink can be further improved.

Specific examples of the aliphatic polyisocyanate include ethylene diisocyanate, tetramethylene diisocyanate, hexamethylene diisocyanate (HDI), dodecamethylene diisocyanate, 1,6,11-undecane triisocyanate, 2,2,4-trimethylhexamethylene diisocyanate, lysine diisocyanate, 2,6-diisocyanato methyl caproate, bis(2-isocyanatoethyl)fumarate, bis (2-isocyanatoethyl)carbonate, 2-isocyanatoethyl-2,6-diisocyanatohexanoate, isophorone diisocyanate, dicyclohexylmethane 4,4′-diisocyanate, and 1,3-bis(isocyanatomethyl)cyclohexane.

One of these aliphatic polyisocyanates may be used alone, or a combination of two or more aliphatic polyisocyanates may be used.

As the polyether polyol, a polyether compound having two or more hydroxyl groups in one molecule, preferably a chain-like polyether compound having two or more hydroxyl groups, and more preferably a polyether diol, can be used.

By ensuring that, in the urethane-based resin (A), the ether linkage are chain-like ether linkages, and is more preferably chain-like ether linkages owing to a polyether diol, the strength of the ink coating film can be further enhanced, and the flexibility of the ink coating film can also be further enhanced. As a result, the durability of the ink coating film can be further enhanced and the workability of the ink coating film can also be further enhanced.

In those cases where the urethane-based resin (A) synthesized using a polyether polyol is used, since the ether portion is unlikely to be affected by hydrolysis, the water resistance of the ink coating film can be further improved.

On the other hand, in those cases where a urethane-based resin synthesized using a polyester polyol is used, the ester portion may be hydrolyzed, and the image quality, the durability and the workability of the ink coating film may sometimes be lowered. In those cases where a urethane-based resin synthesized using a polycarbonate polyol is used, a highly durable ink coating film may be formed, but the workability of the formed ink coating film may sometimes be insufficient.

Specific examples of the polyether polyol include polyether polyols such as polyethylene glycol, polypropylene glycol, and polytetramethylene ether polyol; and polyether polyols obtained by addition polymerization of ethylene oxide, propylene oxide or the like to a low molecular weight polyol such as ethylene glycol, propylene glycol, 1,3-propanediol, 1,4-butanediol, 1,5-pentanediol, 3-methyl-1,5-pentanediol, 1,6-hexanediol, neopentyl glycol, diethylene glycol, trimethylene glycol, triethylene glycol, tetraethylene glycol, dipropylene glycol or tripropylene glycol.

One of these polyether polyols may be used alone, or a combination of two or more polyether polyols may be used.

With respect to the urethane-based resin (A), when a test piece that is a dried film formed from the water-dispersible polyether-type aliphatic urethane-based resin (A) is immersed in the surfactant, which contains the surfactant (C), of the aqueous inkjet ink, and is taken out from the surfactant after 12 hours, a swelling ratio by mass of the urethane-based resin (A), expressed as a swelling ratio by mass of the test piece after the immersion relative to the mass of the test piece before the immersion, is preferably within a range of at least 10% by mass but not more than 100% by mass.

The swelling ratio of the urethane-based resin (A) is a value obtained by the measurement according to the following procedure.

With respect to the combination of the urethane-based resin (A) and the surfactant contained in the measurement object ink, the ratio by mass of swelling of the urethane-based resin (A) caused in a state where the urethane-based resin (A) is immersed in the surfactant is determined. When two or more urethane-based resins are contained in the measurement object ink, for the measurement of the swelling ratio, the two or more urethane-based resins (A) are mixed together such that the mass ratio of these two or more urethane-based resins (A) in the mixture for the measurement of the swelling ratio is the same as the mass ratio of these two or more urethane-based resins (A) in the measurement object ink. Similarly, when two or more surfactants are contained in the measurement object ink, for the measurement of the swelling ratio, the two or more surfactants are mixed together such that the mass ratio of these two or more surfactants in the mixture for the measurement of the swelling ratio is the same as the mass ratio of the two or more surfactants in the measurement object ink. When the measurement object ink contains a surfactant other than the acetylene glycol-based surfactant (C) having an HLB value of not more than 10.0, the surfactant (C) and the surfactant other than the surfactant (C) are mixed together and used for measuring the swelling ratio.

The urethane-based resin (A) has a plurality of ether linkage in its structure. Further, if the surfactant enters the gap in the network structure of the resin, swelling of the resin may be caused. Therefore, the swelling ratio can be controlled by adjusting the crystallinity of the urethane-based resin (A), the molecular weight and the ether linkage amount of the surfactant, the difference in the solubility parameter between the urethane-based resin (A) and the surfactant, and/or the like.

Specifically, the urethane-based resin (A) of the measurement object ink or the resin emulsion thereof is dried at 100° C. to allow water to evaporate sufficiently, thus obtaining a dried film of the urethane-based resin (A), which is used as the test piece. After measuring the mass of the test piece that is the dried film obtained as described above, the test piece is immersed in the surfactant of the measurement object ink, and, after holding the test piece in the surfactant for 12 hours, the test piece is taken out from the surfactant. The surfactant on the surface of the test piece that has been taken out from the surfactant is wiped off, and then, the mass of the test piece is measured. The swelling ratio can be obtained according to the following formula.

Swelling Ratio [%]={((mass of test peace after immersion)−(mass of test piece before immersion))/(mass of test piece before immersion)}×100

The swelling ratio of the urethane-based resin (A) may be within a range from 0 to 150%, and is preferably within a range from 10 to 100%, more preferably from 20 to 80%, and still more preferably from 30 to 60%.

The swelling ratio of the urethane-based resin (A) is preferably at least 10%, more preferably at least 20%, and still more preferably 30% or greater. This further ensures that in the ink coating film, the urethane-based resin (A) can be appropriately softened by the action of the surfactant. As a result, the ink coating film can be given a further flexibility, and the workability of the ink coating film can be further enhanced.

The swelling ratio of the urethane-based resin (A) is preferably not more than 100%, more preferably not more than 80%, and still more preferably 60% or less. In this range, the urethane-based resin (A) may be further prevented from becoming too soft by the action of the surfactant. As a result, the strength of the ink coating film can be further enhanced, and the durability of the ink coating film can be enhanced.

The urethane-based resin (A) is preferably a resin that forms a transparent coating film on a substrate. When such a resin is used as the urethane-based resin (A), the influence on the color development of the aqueous ink can be reduced. The use of a polyether-based aliphatic urethane-based resin as the urethane-based resin (A) may enable prevention of the yellowing and degradation of the resin in the heat treatment in the formation of the ink coating film, and the color development of the aqueous ink can be further enhanced.

The weight average molecular weight (Mw) of the urethane-based resin (A) is not particularly limited, but is preferably within a range from 10,000 to 100,000, and more preferably from 15,000 to 80,000. Here, the resin weight average molecular weight refers to a value determined as a polystyrene-equivalent weight average molecular weight by the gel permeation (GPC) method. This also applies to weight average molecular weight values described hereafter unless otherwise specified.

The urethane-based resin (A) can be added in the ink in the form of an oil-in-water (O/W) resin emulsion which forms particles in the ink, and the urethane-based resin (A) is preferably in the form of resin particles in the ink.

The average particle size of the resin particles of the urethane-based resin (A) in the ink may be any size suitable for inkjet printing, and generally, the average particle size is preferably not more than 300 nm. The average particle size is more preferably not more than 250 nm, more preferably not more than 200 nm, and still more preferably 150 nm or less, from the viewpoints of ink jetting performance and ink storage stability. Further, when a pigment is used as the colorant, the average particle size of the resin particles is preferably smaller than the average particle size (generally, from about 80 to about 200 nm) of the pigment from the viewpoint of further enhancing the binding property of the pigment particles.

The lower limit value of the average particle size of the resin particles of the urethane-based resin (A) in the ink is not particularly limited, but the average particle size is preferably at least 5 nm, and more preferably 10 nm or greater, from the viewpoint of the storage stability of the ink.

In this specification, unless otherwise specified, the average particle size is a volume-based particle size value (median diameter) in a particle size distribution measured using the dynamic light scattering method. A nanoparticle analyzer nanoPartica SZ-100 (manufactured by Horiba, Ltd.) or the like can be used as the dynamic light scattering type particle size distribution measuring device.

Examples of commercially available resin emulsions of the urethane-based resin (A) include “TAKELAC W-5661” and “TAKELAC W-6020” manufactured by Mitsui Chemicals Inc., “PERMARIN UA-200” manufactured by Sanyo Chemical Industries, Ltd., “SUPERFLEX 130”, “SUPERFLEX 870” and “SUPERFLEX E-4800” manufactured by DKS Co., Ltd., “ADEKA BONTIGHTER HUX-350” and “ADEKA BONTIGHTER HUX-550” manufactured by ADEKA CORPORATION, and “WBR-016U” manufactured by Taisei Fine Chemical Co., Ltd (wherein all of the above represent product names).

The amount of the urethane-based resin (A), expressed as a solid fraction amount, may be within a range from 0.1 to 15% by mass or from 1 to 10% by mass, relative to the total mass of the ink. The amount of the urethane-based resin (A), expressed as the solid fraction amount, is preferably within a range from 3 to 8% by mass, more preferably from 3 to 5% by mass, relative to the total mass of the ink.

The amount of the urethane-based resin (A), expressed as the solid fraction amount, is preferably at least 0.1% by mass, more preferably at least 1% by mass, and still more preferably 3% by mass or greater, relative to the total mass of the ink. The urethane-based resin (A) alone tends to exhibit a lower film strength than the (meth)acrylic-based resin (B), but, by the interaction between the urethane-based resin (A) and the (meth)acrylic-based resin (B), the strength of the ink coating film can be further enhanced, and the durability of the ink coating film can be further improved. When a larger amount of the urethane-based resin (A) is contained, the flexibility of the ink coating film can be further enhanced. Thus, when the portion having the ink coating film of the printed matter is subjected to processing such as bending, the ink coating film can be flexibly deformed along the processed shape, and cracks and whitening phenomena in the processed portion can be further prevented.

The amount of the urethane-based resin (A), expressed as a solid fraction amount, is preferably not more than 15% by mass, more preferably not more than 10% by mass, still more preferably not more than 8% by mass, and still more preferably 5% by mass or less, relative to the total mass of the ink. When the amount of the urethane-based resin (A) is within this range, the resin amount in the ink can be appropriately controlled while properly maintaining the blending balance with the (meth)acrylic-based resin (B), the viscosity increase of the ink can be further prevented, and the ink jetting performance can be further improved.

The amount of the urethane-based resin (A), expressed as a mass ratio of the solid fraction amount relative to a value of 1 for the colorant, is preferably within a range from 0.5 to 10, more preferably from 1 to 8, and still more preferably from 1.5 to 2.

The ink according to one embodiment may contain a water-dispersible (meth)acrylic-based resin (B).

The (meth)acrylic-based resin refers to a polymer containing at least one selected from the group consisting of a methacrylic-based unit, an acrylic-based unit, and a combination thereof.

Since the (meth)acrylic-based resin (B) exhibits water dispersibility, the (meth)acrylic-based resin (B) is able to be dispersed in water without dissolving, thus forming an oil-in-water (O/W) resin emulsion. The (meth)acrylic-based resin (B) is preferably contained in the ink in a dispersed state as resin particles.

The (meth)acrylic-based resin (B) may be any of an anionic resin, a cationic resin, an amphoteric resin, and a nonionic resin. From the viewpoint of the stability of the colorant in water, an anionic resin, an amphoteric resin and/or a nonionic resin can be preferably used, since, in many of colorants suitable for aqueous inks, the surface charge of the colorant dispersed in water is anionic.

The water-dispersible (meth)acrylic-based resin (B) may be a resin in which functional groups of the resin exist at the particle surfaces, such as a self-emulsifying resin. The water-dispersible (meth)acrylic-based resin (B) may be a resin that has been subjected to a surface treatment such as adhering a dispersant to the surface of the resin particles.

The (meth)acrylic-based resin (B) is preferably a polymer containing a unit derived from a (meth)acrylic-based monomer. The (meth)acrylic-based resin (B) may contain one or more units derived from another monomer together with a unit derived from a (meth)acrylic-based monomer.

Examples of the (meth)acrylic-based monomer include acrylic acid, methacrylic acid, acrylate, methacrylate, acrylamide, methacrylamide, acrylonitrile, methacrylonitrile, and derivatives thereof. One of these (meth)acrylic-based monomers may be used alone, or a combination of two or more (meth)acrylic-based monomers may be used.

Examples of other units that may be contained in the (meth)acrylic-based resin (B) include styrene units, vinyl acetate units, and vinyl chloride unit. One kind of these units may be used alone or a combination of two or more kinds of units may be used.

Examples of the (meth)acrylic-based resin (B) include a (meth)acrylic polymer, a styrene-(meth)acrylic copolymer, a vinyl acetate-(meth)acrylic copolymer, a vinyl chloride-(meth)acrylic copolymer, and a combination thereof. Preferable examples of the (meth)acrylic-based resin (B) include a (meth)acrylic polymer, a styrene-(meth)acrylic copolymer, and a combination thereof.

The (meth)acrylic-based resin (B) is preferably a resin that forms a transparent coating film on a substrate. This ensures that the influence on the color development of the aqueous ink can be further reduced.

The weight average molecular weight (Mw) of the (meth)acrylic-based resin (B) is not particularly limited, but is preferably within a range from 1,000 to 100,000, and more preferably from 5,000 to 80,000.

The (meth)acrylic-based resin (B) can be added in the ink in the form of an oil-in-water (O/W) resin emulsion which forms particles in the ink, and the (meth)acrylic-based resin (B) is preferably in the form of resin particles in the ink.

The average particle size of the resin particles of the (meth)acrylic-based resin (B) in the ink may be any size suitable for inkjet printing, and is preferably within the numerical ranges as described above for the urethane-based resin (A).

Examples of commercially available resin emulsions of (meth)acrylic-based resin (B) include “Mowinyl 9780”, “Mowinyl 727”, “Mowinyl 745”, “Mowinyl 966A”, and “Mowinyl 940” manufactured by Japan Coating Resin Corporation; “Joncryl 7100”, “Joncryl PDX-7370,and “Joncryl PDX-7341” manufactured by BASF; “Voncoat EC-905EF”, “Voncoat 5400EF, and “Voncoat CG-8400” manufactured by DIC Corporation; and “NeoCryl A-1125”, “NeoCryl A-1125”, “NeoCryl A-1127”, “NeoCryl A-6069”, “NeoCryl A-1092”, and “NeoCryl A-2092” manufactured by DSM (wherein all of the above represent product names).

The amount of the (meth)acrylic-based resin (B), expressed as a solid fraction amount, may be, within a range from 0.1 to 15% by mass or from 1 to 10% by mass, relative to the total mass of the ink. The amount of the (meth)acrylic-based resin (B), expressed as the solid fraction amount, is preferably within a range from 1 to 8% by mass, and more preferably from 2 to 5% by mass, relative to the total mass of the ink.

The amount of the (meth)acrylic-based resin (B), expressed as the solid fraction amount, is preferably at least 0.1% by mass, more preferably at least 1% by mass, and still more preferably 2% by mass or greater, relative to the total mass of the ink. When the amount of the (meth)acrylic-based resin (B) is within such a range, the strength of the ink coating film can be further enhanced, and the durability of the ink coating film can be further improved. Although the flexibility of the ink coating film tends to be insufficient with the (meth)acrylic-based resin (B) alone, both the strength and the flexibility of the ink coating film can be improved by the interaction between the urethane-based resin (A) and the (meth)acrylic-based resin (B), and, as result, the durability and the workability of the ink coating film can be further enhanced.

The amount of the (meth)acrylic-based resin (B), expressed as the solid fraction amount, is preferably not more than 15% by mass, more preferably not more than 10% by mass, still more preferably not more than 8% by mass, and still more preferably 5% by mass or less, relative to the total mass of the ink. When the amount of the (meth)acrylic-based resin (B) is within such a range, the resin amount in the ink can be appropriately controlled while properly maintaining the blending balance with the urethane-based resin (A). Accordingly, the viscosity increase of the ink can be further prevented, and the ink jetting performance can be further improved.

The amount of the (meth)acrylic-based resin (B), expressed as a mass ratio of the solid fraction amount relative to a value of 1 for the colorant, is preferably within a range from 0.1 to 8, more preferably from 0.5 to 5, and still more preferably from 1 to 3.

The total amount of the urethane-based resin (A) and the (meth)acrylic-based resin (B), expressed as the solid fraction amount, is preferably at least 1% by mass, more preferably at least 3% by mass, and still more preferably 5% by mass or greater, relative to the total mass of the ink.

The total amount of the urethane-based resin (A) and the (meth)acrylic-based resin (B), expressed as the solid fraction amount, is preferably not more than 20% by mass, more preferably not more than 10% by mass, and still more preferably 8% by mass or less, relative to the total mass of the ink.

For example, the total amount of the urethane-based resin (A) and the (meth)acrylic-based resin (B), expressed as the solid fraction amount, is preferably within a range from 1 to 20% by mass, more preferably from 3 to 10% by mass, and still more preferably from 5 to 8% by mass, relative to the total mass of the ink.

In the mass ratio of the amounts in the ink, the mass of the urethane-based resin (A) is preferably larger than the mass of the (meth)acrylic-based resin (B).

The mass ratio of the urethane-based resin (A) relative to the total mass of the urethane-based resin (A) and the (meth)acrylic-based resin (B) is preferably within a range from 10 to 90% by mass, more preferably from 20 to 80% by mass, and still more preferably from 40 to 70% by mass.

The ink according to one embodiment may contain one or more resins other than the urethane-based resin (A) or the (meth)acrylic-based resin (B). For example, a binder resin can be contained as these other resins.

As these other resins, a water-dispersible resin, a water-soluble resin or a combination thereof may be used.

As to these other resins, examples of the water-dispersible resins include ethylene-vinyl chloride copolymer resins, styrene-maleic anhydride copolymer resins, and vinyl acetate-ethylene copolymer resins. These water-dispersible resins can be incorporated into the ink in the form of an oil-in-water (O/W) resin emulsions.

Examples of the water-soluble resins include polyvinyl alcohol, polyacrylic acid, neutralized products of polyacrylic acid, acrylic acid/maleic acid copolymers, acrylic acid/sulfonic acid copolymers, and styrene/maleic acid copolymers. Anionic functional groups may be introduced to these resins to obtain anionic water-soluble resins, and, as the water-soluble resin, an anionic water-soluble resin having anionic introduced therein may be used.

One of these other resins may be used alone, or a combination of two or more thereof may be used.

The amount (active ingredient amount) of these other resins is preferably within a range from 1 to 20% by mass relative to the total mass of the ink. When these other resins is contained in the ink, the total amount of the urethane-based resin (A) and the (meth)acrylic-based resin (B) is preferably at least 50% by mass, more preferably at least 80% by mass, and still more preferably 90% by mass or greater, relative to the total mass of all the resins contained in the ink.

The ink according to one embodiment may contain an acetylene glycol-based surfactant (C) having an HLB value of not more than 10.0.

The acetylene glycol-based surfactant (C) is a glycol having an acetylene group, and is preferably a glycol having a symmetrical structure in which an acetylene group is positioned at the center. The acetylene glycol-based surfactant (C) may have a structure in which ethylene oxide is added to acetylene glycol.

When an ethylene oxide-adduct of acetylene glycol is used as the acetylene glycol-based surfactant (C), the number of added moles of ethylene oxide is preferably not more than 5, more preferably not more than 4, and still more preferably 3 or less.

The HLB value of the acetylene glycol-based surfactant (C) is preferably not more than 10.0, is more preferably not more than 9.0, is still more preferably 8.0 or less, and may be 5.0 or less. This may enable the coating property of the resin component contained in the ink, in particular the urethane-based resin (A), to be further improved. As a result, the strength of the ink coating film can be further improved, and the durability of the ink coating film can be further enhanced. Since the urethane-based resin (A) can be coated further uniformly, the flexibility of the ink coating film can be further improved, and the workability of the ink coating film can be further enhanced.

Although the lower limit value of the HLB value of the acetylene glycol-based surfactant (C) is not particularly limited, the HLB value of the acetylene glycol-based surfactant (C) is preferably at least 1.0, is more preferably at least 2.0, and may be 3.0 or greater, from the viewpoint of the storage stability of the ink.

For example, the acetylene glycol-based surfactant (C) preferably has an HLB value of from 1.0 to 10.0, more preferably has an HLB value of from 2.0 to 8.0, and still more preferably has an HLB value of from 3.0 to 5.0.

Here, the HLB value is one of the scales indicating the properties of the surfactant, and is a numerical expression of the balance between hydrophilic groups and lipophilic groups in the molecule. Although several calculation methods have been proposed for the HLB value, the HLB value in this specification is a value calculated in accordance with the Griffin method and is calculated by the following formula (1).

HLB value=20×(formula weight of hydrophilic part)/(molecular weight of surfactant) Formula (1)

Here, the “hydrophilic part” represents a hydrophilic portion contained in the molecular structure of the surfactant, and is preferably a polyoxyalkylene group, an alcohol group having 3 or less main chain carbon atoms per one hydroxyl group, or a combination thereof. When the surfactant contains a plurality of hydrophilic portions, the “formula weight of the hydrophilic part” in the formula (1) represents the total of those of the plurality of hydrophilic portions.

Examples of the polyoxyalkylene group include a polyoxyethylene group (polyethylene oxide; EO: —(CH₂CH₂O)ₙ—) and a polyoxypropylene group (polypropylene oxide; PO: —(CH₂CH₂CH₂O)ₙ—).

Examples of the alcohol group include a group derived from methanol, ethanol, propanol, isopropanol, glycerol, polyglycerol, trimethylolpropane, pentaerythritol, sorbitol, sorbitan, sucrose, mannitol, glycols or the like. Specific examples of the alcohol group include —CH₂CH₂OH, which is a group derived from ethanol.

The “hydrophobic part” represents a hydrophobic portion contained in the molecular structure of the surfactant, and may be an aliphatic hydrocarbon group derived from an aliphatic alcohol having 4 or more main chain carbon atoms per one hydroxyl group, an alkylphenol, a fatty acid, or the like; an aromatic hydrocarbon group; a group derived from an organosiloxane, an alkyl halide, or the like; or a combination thereof.

Examples of commercially available acetylene-based surfactant (C) having an HLB value of not more than 10.0 include “OLFINE E1004”, “SURFYNOL 420”, “SURFYNOL 440” and “SURFYNOL 104” available from Nisshin Chemical Industry Co., Ltd (all product names).

One of these acetylene glycol-based surfactants (C) may be used alone, or a combination of two or more acetylene glycol-based surfactants (C) may be used.

The amount of the surfactant (C), expressed as an active ingredient amount, is preferably at least 0.1% by mass, more preferably at least 0.5% by mass, and still more preferably I% by mass or greater, relative to the total mass of the ink. When the amount of the surfactant (C) relative to the total mass of the ink is within such a range, in the formation of the coating film with the urethane-based resin (A) and the (meth)acrylic-based resin (B), the affinity with the substrate to which the ink is applied can be further improved, and a stronger ink coating film can be formed. As a result, the durability of the ink coating film can be further enhanced. In addition, the urethane-based resin (A) may swell by the action of the surfactant, and thus the flexibility may be further imparted, whereby the workability of the ink coating film can be further improved.

The amount of the surfactant (C) is preferably not more than 10% by mass, more preferably not more than 5% by mass, and still more preferably 3% by mass or less, relative to the total mass of the ink. In this range, the deterioration of the storage stability of the ink can be further prevented.

For example, the amount of the surfactant (C), expressed as an active ingredient amount, is preferably within a range from 0.1 to 10% by mass, more preferably from 0.5 to 5% by mass, and still more preferably from 1 to 3% by mass, relative to the total mass of the ink.

The amount of the surfactant (C), expressed as a mass ratio of the active ingredient amount relative to a value of 1 for the solid fraction amount of urethane-based resin (A), is preferably within a range from 0.1 to 1, more preferably from 0.2 to 0.5.

The amount of the surfactant (C), expressed as a mass ratio of the active ingredient amount relative to a value of 1 for the solid fraction amount of the (meth)acrylic-based resin (B), is preferably within a range from 0.1 to 2, and more preferably from 0.5 to 1.

The ink according to one embodiment may contain one or more surfactants other than the surfactant (C) described above. As the surfactant other than the surfactant (C), a nonionic surfactant, an anionic surfactant, or a combination thereof may be preferably used, and, a nonionic surfactant is more preferably used.

As the surfactant other than the surfactant (C), an acetylene glycol-based surfactant having an HLB value of greater than 10.0 may be used.

Examples of commercially available acetylene-based surfactants having an HLB value of greater than 10.0 include “OLFINE E1010”, “OLFINE E1006”, “OLFINE E1020”, “SURFYNOL 465”, and “SURFYNOL 485” (all product names) manufactured by Nisshin Chemical Industry Co., Ltd.

Examples of the surfactants other than the surfactant (C) include ester-based surfactants such as glycerol fatty acid esters and sorbitan fatty acid esters; ether-based surfactants such as polyoxyethylene alkyl ethers, polyoxyethylene alkyl phenyl ethers and polyoxypropylene alkyl ethers; ether-ester-based surfactants such as polyoxyethylene sorbitan fatty acid esters; acetylene alcohol-based surfactants; surfactants having an acetylene group; silicone-based surfactants; and fluorine-based surfactants. Among these, preferable examples include acetylene alcohol-based surfactants, surfactants having an acetylene group, and silicone-based surfactants.

In those cases where the surfactant other than surfactant (C) is contained in the ink, the amount of the surfactant (C), expressed as an active ingredient amount, is preferably at least 50% by mass, more preferably at least 80% by mass, and still more preferably 90% by mass or greater, relative to the total amount of surfactant.

The ink may contain a colorant. The colorant may contain a pigment, a dye, or a combination thereof. From the viewpoint of the weather resistance and color development of the image, a pigment is preferably used as the colorant.

The pigment can be preferably incorporated into the ink in the form of a pigment dispersion.

The pigment dispersion may be the one with which the pigment can be dispersed in a solvent and with which the pigment can be in a dispersed state in the ink. Examples of the pigment dispersion which can be used include a dispersion in which a pigment is dispersed in water with a pigment dispersant, a dispersion in which a self-dispersing pigment is dispersed in water, and a dispersion in which a microencapsulated pigment, which is a pigment coated with a resin, is dispersed in water.

Examples of pigments which may be used include organic pigments such as azo pigments, phthalocyanine pigments, polycyclic pigments, and dye lake pigments; and inorganic pigments such as carbon blacks and metal oxides. Examples of the azo pigments include soluble azo lake pigments, insoluble azo pigments and condensed azo pigments. Examples of the phthalocyanine pigments include metal phthalocyanine pigments such as copper phthalocyanine pigments and metal-free phthalocyanine pigments. Examples of the polycyclic pigments include quinacridone-based pigments, perylene-based pigments, perinone-based pigments, isoindoline-based pigments, isoindolinone-based pigments, dioxazine-based pigments, thioindigo-based pigments, anthraquinone-based pigments, quinophthalone-based pigments, metal complex pigments, and diketopyrrolopyrrole (DPP). Examples of the carbon black include furnace carbon black, lamp black, acetylene black, and channel black.

Examples of the organic pigments further include brilliant carmine 6B, lake red C, Watching red, disazo yellow, Hanza yellow, phthalocyanine blue, phthalocyanine green, alkali blue, and aniline black.

Examples of the inorganic pigments include metals such as cobalt, iron, chromium, copper, zinc, lead, titanium, vanadium, manganese, and nickel, as well as metal oxides and sulfides thereof, and ochre, ultramarine, and dark blue.

A white pigment may be used as the pigment. Examples of the white pigments include inorganic pigments such as titanium oxide, zinc oxide, zinc sulfide, antimony oxide, and zirconium oxide.

Specific examples of the pigment include Pigment Yellow 12, Pigment Yellow 13, Pigment Yellow 14, Pigment Yellow 17, Pigment Yellow 20, Pigment Yellow 24, Pigment Yellow 74, Pigment Yellow 83, Pigment Yellow 86, Pigment Yellow 93, Pigment Yellow 94, Pigment Yellow 95, Pigment Yellow 109, Pigment Yellow 110, Pigment Yellow 117, Pigment Yellow 120, Pigment Yellow 125, Pigment Yellow 128, Pigment Yellow 137, Pigment Yellow 138, Pigment Yellow 139, Pigment Yellow 147, Pigment Yellow 148, Pigment Yellow 150, Pigment Yellow 151, Pigment Yellow 154, Pigment Yellow 155, Pigment Yellow 166, Pigment Yellow 168, Pigment Yellow 180, Pigment Yellow 185; Pigment Orange 16, Pigment Orange 36, Pigment Orange 38, Pigment Orange 43, Pigment Orange 51, Pigment Orange 55, Pigment Orange 59, Pigment Orange 61, Pigment Orange 64, Pigment Orange 65, Pigment Orange 71; Pigment Red 9, Pigment Red 48, Pigment Red 49, Pigment Red 52, Pigment Red 53, Pigment Red 57, Pigment Red 97, Pigment Red 122, Pigment Red 149, Pigment Red 168, Pigment Red 177, Pigment Red 178, Pigment Red 179, Pigment Red 206, Pigment Red 207, Pigment Red 209, Pigment Red 242, Pigment Red 254, Pigment Red 255; Pigment Violet 19, Pigment Violet 23, Pigment Violet 29, Pigment Violet 30, Pigment Violet 37, Pigment Violet 40, Pigment Violet 50; Pigment Blue 15, Pigment Blue 15:1, Pigment Blue 15:3, Pigment Blue 15:4, Pigment Blue 15:6, Pigment Blue 22, Pigment Blue 30, Pigment Blue 64, Pigment Blue 80; Pigment Green 7 (chlorinated phthalocyanine green), Pigment Green 36 (brominated phthalocyanine green); Pigment Brown 23, Pigment Brown 25, Pigment Brown 26; Pigment Black 7 (carbon black), Pigment Black 26, Pigment Black 27, and Pigment Black 28.

Examples of commercially available carbon blacks include MONARCH 1000, and ELFTEX 415 (these are carbon blacks manufactured by Cabot Corporation); and #960, #970, MA8, and MA77 (these are carbon blacks manufactured by Mitsubishi Chemical Corporation).

Examples of commercially available color pigments include LIONOL BLUE FG-7400G (a phthalocyanine pigment, manufactured by Toyo Color Co., Ltd.); Yellow Pigment E4GN (a nickel complex azo pigment manufactured by Bayer); Cromophthalmic Pink PT (a quinacridone pigment manufactured by BASF); Fastogen Super Magenta RG (a quinacridone pigment manufactured by DIC Corporation); Fastogen Super Magenta RGT (a quinacridone pigment manufactured by DIC Corporation); YELLOW PIGMENT E4GN (a nickel complex azo pigment manufactured by Lanxess); Irgalite Blue 8700 (a phthalocyanine pigment manufactured by BASF); E4GN-GT (a nickel complex azo pigment manufactured by Lanxess); Fastogen Blue TGR (a cyan pigment, manufactured by DIC Corporation); Cinquasia Magenta D4550J (a magenta pigment manufactured by BASF); and Inkjet Yellow 4GP (a yellow pigment manufactured by Clariant).

The average particle size of the pigment is preferably within a range from 50 to 500 nm, and more preferably from 50 to 200 nm. The average particle size of the pigment is preferably at least 50 nm from the viewpoint of color development. The average particle size of the pigment is preferably 500 nm or less from the viewpoint of jetting stability.

A pigment dispersant typified by polymeric dispersants and surfactant-type dispersants is preferably used to ensure stable dispersion of the pigment in the ink.

Examples of commercially available polymeric dispersants include the TEGO Dispers series manufactured by Evonik Industries AG (including “TEGO Dispers 740W”, “TEGO Dispers 750W”, “TEGO Dispers 755W”, “TEGO Dispers 757W”, and “TEGO Dispers 760W”), the Solsperse Series manufactured by The Lubrizol Corporation (including “Solsperse 20000”, “Solsperse 27000”, “Solsperse 41000”, “Solsperse 41090”, “Solsperse 43000”, “Solsperse 44000”, and “Solsperse 46000”), the Joncryl series manufactured by Johnson Polymer, Inc. (including “Joncryl 57”, “Joncryl 60”, “Joncryl 62”, “Joncryl 63”, “Joncryl 71”, and ““Joncryl 501”), “DISPERBYK-102”, “DISPERBYK-185”, “DISPERBYK-190”, “DISPERBYK-193”, and “DISPERBYK-199” manufactured by BYK, and “K-30” and “K-90”, which are polyvinylpyrrolidones manufactured by DKS Co., Ltd. (wherein all of the above represent product names).

In consideration of the dispersion stability of the pigment in the ink and the influence of the ionicity from the pretreatment agent, a nonionic surfactant can preferably be used as the surfactant-type dispersant.

Examples of commercially available surfactant-type dispersants include nonionic surfactants such as the EMULGEN series manufactured by Kao Corporation (including “EMULGEN A-60”, “EMULGEN A-90”, “EMULGEN A-500”, “EMULGEN B-40”, “EMULGEN L-40”, and “EMULGEN 420” (all product names)).

One of these pigment dispersants may be used alone, or a combination of two or more pigment dispersants may be used.

In those cases where a pigment dispersant is used, there are no particular limitations on the amount of the pigment dispersant in the ink, which varies depending on the type of dispersant used. The amount of the pigment dispersant, expressed as a mass ratio of the active ingredient relative to a value of 1 for the pigment, may be, for example, within a range from 0.005 to 0.5.

A self-dispersing pigment may be incorporated as the colorant. The self-dispersing pigment is a pigment in which a hydrophilic functional group has been introduced into the surface of the pigment by a chemical treatment or physical treatment. The hydrophilic functional group to be introduced into the self-dispersing pigment is preferably the one having ionicity. The pigment particles can be stably dispersed in water by electrostatic repulsive force by anionically or cationically charging the surface of the pigment. Examples of preferable anionic functional groups include a sulfo group, a carboxy group, a carbonyl group, a hydroxyl group, and a phosphonic acid group, phosphate group. Examples of preferable cationic functional groups include a quaternary ammonium group, and a quaternary phosphonium group.

These hydrophilic functional groups may be directly bonded to the pigment surface or may be bonded through another atomic group. Examples of atomic groups which may be provided between the hydrophilic functional group and pigment surface include, but are not limited to, an alkylene group, a phenylene group, and a naphthylene group. Examples of the pigment surface treatment method include a diazotization treatment, a sulfonation treatment, a hypochlorous acid treatment, a humic acid treatment, and a vacuum plasma treatment.

Preferable examples of the self-dispersing pigments include CAB-O-JET series manufactured by Cabot Corporation (including “CAB-O-JET 200”, “CAB-O-JET 300”, “CAB-O-JET 250C”, “CAB-O-JET 260M”, and “CAB-O-JET 270”), and the products “BONJET BLACK CW-1”, “BONJET BLACK CW-2”, and “BONJET BLACK CW-4” manufactured by Orient Chemical Industries, Ltd (wherein all of the above represent product names).

A pigment dispersion in which a pigment has been dispersed in advance with a pigment dispersant may be used. Examples of commercially available pigment dispersion containing a pigment dispersed with a pigment dispersant include HOSTAJET series manufactured by Clariant, FUJI SP series manufactured by Fuji Pigment Co., Ltd. (all product names). A pigment dispersion in which a pigment is dispersed with the above described pigment dispersant may be used. A microencapsulated pigment in which the pigment is coated with a resin may be used.

A dye may be contained as a colorant. In terms of dyes, any of the dyes typically used in the technical field of printing may be used without any particularly limitations. Specific examples include basic dyes, acid dyes, direct dyes, soluble vat dyes, acid mordant dyes, mordant dyes, reactive dyes, vat dyes, and sulfide dyes. Among these, water-soluble dyes and dyes that become water-soluble upon reduction or the like may be preferably used. Specific examples of dyes include azo dyes, rhodamine dyes, methine dyes, azomethine dyes, xanthene dyes, quinone dyes, triphenylmethane dyes, diphenylmethane dyes, and methylene blue.

One of the above-described colorant can be used alone, or a combination of two or more colorants may be used.

The amount of the colorant, expressed as an active ingredient amount, is preferably within a range from 0.1 to 20% by mass, more preferably from 1 to 10% by mass, and still more preferably from 2 to 5% by mass, relative to the total mass of the ink.

The ink preferably contains water as an aqueous solvent. The ink may contain water as the main solvent. In those cases in which water is contained as a solvent in the above described resin emulsion, the above described pigment dispersion and/or the like, the water contained in such component is calculated into a part of the water contained in the ink, for the preparation of the ink.

There no particular limitation on the water, but is preferably the one in which an amount of ionic component contained therein is as low as possible. In particular, from the viewpoint of the storage stability of the ink, the amount of polyvalent metal ions such as a calcium ion therein is preferably small. Examples of the water which may be used include ion-exchanged water, distilled water, and ultrapure water.

From the viewpoint of adjusting the ink viscosity, the amount of water in the ink, relative to the total mass of ink, is preferably within a range from 20 to 90% by mass, and more preferably from 30 to 80% by mass.

The ink may contain a water-soluble organic solvent. The water-soluble organic solvent is preferably compatible with water. Organic compounds that are liquid at room temperature and soluble in or miscible with water may be used as the water-soluble organic solvent. The use of a water-soluble organic solvent that mixes uniformly with an equal volume of water at one atmosphere and 20° C. is preferred.

Examples of water-soluble organic solvents that may be used include lower alcohols such as methanol, ethanol, 1-propanol, isopropanol, 1-butanol, 2-butanol, isobutanol and 2-methyl-2-propanol; glycols such as ethylene glycol, diethylene glycol, triethylene glycol, tetraethylene glycol, pentaethylene glycol, propylene glycol, dipropylene glycol, tripropylene glycol, and 1,3-propanediol; glycerols such as glycerol, diglycerol, triglycerol, and polyglycerols; acetins such as monoacetin and diacetin; glycol ethers such as ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, triethylene glycol monopropyl ether, triethylene glycol monobutyl ether, tetraethylene glycol monomethyl ether, tetraethylene glycol monoethyl ether, tetraethylene glycol dimethyl ether, and tetraethylene glycol diethyl ether; triethanolamine, 1-methyl-2-pyrrolidone, 1,3-dimethyl-2-imidazolidinone, 3-thiodiglycol, and sulfolane.

One of these water-soluble organic solvents may be used alone, or a combination of two or more water-soluble organic solvents may be used as long as they form a single phase.

Among water soluble organic solvents, a glycol, a glycol ether, or a combination thereof may be preferably used, and a glycol ether may be more preferably used. These water-soluble organic solvents have better compatibility with water. The dispersion stability of the urethane-based resin (A) and the (meth)acrylic-based resin (B) can be further improved in the mixed solvent of such a water-soluble organic solvent and water.

Examples of water-soluble organic solvents that may be preferably used further include low-polarity solvents. A surfactant having a low HLB value tends to exhibit poor solubility in an aqueous solvent and may sometimes float in the ink. In such a case, the solubility of the surfactant having a low HLB value can be enhanced by adding a low-polarity solvent to the ink. Examples of the low-polarity solvents that may be preferably used include diethylene glycol monoethyl ether, diethylene glycol monomethyl ether, diethylene glycol monobutyl ether, propylene glycol monomethyl ether, propylene glycol monoethyl ether, triacetin, 3,5,5-trimethyl-2-cyclohexene-1-one, and 2-pyrrolidone.

The amount of the water-soluble organic solvent, relative to the total mass of the ink, may be within a range from 1 to 80% by mass, more preferably from 10 to 60% by mass, and still more preferably from 20 to 50% by mass, from the viewpoints of viscosity adjustment and moisturizing effect.

The amount of the low polarity water-soluble organic solvent is preferably within a range from 1 to 20% by mass, more preferably from 1 to 10% by mass, and still more preferably from 2 to 3% by mass.

Besides the components as described above, the ink may optionally contain a wetting agent (moisturizer), a surface tension adjuster (penetrant), an antifoaming agent, a fixing agent, a pH adjuster, an antioxidant, a preservative, and/or the like.

Any of known pH adjusters may be added to adjust the pH of the ink. Sulfuric acid, nitric acid, acetic acid, sodium hydroxide, potassium hydroxide, ammonium hydroxide, triethanolamine, and/or the like can be used as a pH adjuster, or as a thickening aid for the ink.

The addition of the antioxidant can prevent the oxidation of the ink components and can improve the storage stability of the ink. Examples of the antioxidants that may be used include L-ascorbic acid, sodium L-ascorbate, sodium isoascorbate, potassium sulfite, sodium sulfite, sodium thiosulfate, sodium dithionite, and sodium pyrosulfite.

When the ink contains a preservative, the storage stability of the ink can be improved by preventing the ink from decomposition. Examples of the preservatives that may be used include isothiazolone-based preservatives such as 5-chloro-2-methyl-4-isothiazoline-3-one, 2-methyl-4-isothiazoline-3-one, 2-n-octyl-4-isothiazoline-3-one, and 1,2-benzisothiazoline-3-one; triazine-based preservatives such as hexahydro-1,3,5-tris(2-hydroxyethyl)-s-triazine; pyridine/quinoline-based preservatives such as sodium-2-pyridinethiol-1-oxide and 8-oxyquinoline; dithiocarbamate-based preservatives such as sodium dimethyldithiocarbamate; organobromine-based preservatives such as 2,2-dibromo-3-nitrilopropionamide, 2-bromo-2-nitro-1,3 propanediol, 2,2-dibromo-2-nitroethanol, 1,2-dibromo-2,4-dicyanobutane; methyl p-hydroxybenzoate, ethyl p-hydroxybenzoate, potassium sorbate, sodium dehydroacetate, and salicylic acid.

The suitable range for the viscosity of the ink may vary depending on factors such as the diameter of the nozzles in the jetting head, the jetting environment and the like, but, generally, the viscosity at 23° C. is preferably within a range from 1 to 30 mPa·s, and more preferably from 5 to 15 mPa·s. The viscosity within such range is suitable for the use in an inkjet printing apparatus. The viscosity of the ink can be measured using a rotation viscometer.

The method for producing the ink is not particularly limited, but desired ink can be obtained by appropriately mixing together the components. For example, when a pigment dispersion is used for a colorant, a mixture of a pigment, a pigment dispersant and water may be dispersed using a dispersing device such as a bead mill to obtain a pigment dispersion, and then the pigment dispersion, a resin emulsion of a urethane-based resin (A), a resin emulsion of a (meth)acrylic-based resin (B), a surfactant (C), water and a water-soluble organic solvent can be mixed together either in a single batch or in a number of separate batches to obtain an ink. The obtained composition may be filtered through a filter or the like.

The amount of the solid fraction in the resin emulsion of the urethane-based resin (A) to be formulated in the ink is preferably within a range from 10 to 50% by mass, more preferably from 30 to 40% by mass.

The resin emulsion of the urethane-based resin (A) to be formulated in the ink preferably has a viscosity measured in the emulsion state within a range from 1 to 300 mPa·s, and more preferably from 1 to 100 mPa·s.

The amount of the solid fraction in the resin emulsion of the (meth)acrylic-based resin (B) to be formulated in the ink is preferably within a range from 10 to 50% by mass.

The resin emulsion of the (meth)acrylic-based resin (B) to be formulated in the ink preferably has a viscosity at 23° C. measured in the emulsion state within a range from 1 to 300 mPa·s, more preferably from 1 to 100 mPa·s.

In order to perform high-quality printing on various substrates having different surface energies, the wetting and spreading properties of the ink may be considered. From this point, the viscosity of the resin emulsion in the ink is preferably lower.

The aqueous inkjet ink according to one embodiment may be printed on an untreated substrate or printed on a substrate that has been treated with a pretreatment agent. In particular, when a substrate having low-permeability is used as the substrate, it is preferable to treat the substrate with a pretreatment agent because the aqueous inkjet ink tends to be less able to permeate into such a substrate.

The pretreatment agent preferably contains an aqueous medium, and also contains a surfactant, a coagulant, inorganic particles or the like, or a combination thereof. More preferably, the pretreatment agent contains an aqueous medium, and a surfactant and/or a coagulant. The pretreatment agent may contain a binder resin for fixing the coagulant to the substrate.

The amount of the surfactant, expressed as an active component amount, is preferably within a range from 0.1 to 10% by mass, more preferably from 0.5 to 5% by mass, and still more preferably from 0.7 to 2% by mass, relative to the total mass of the pretreatment agent.

The amount of binder resin, expressed as an active ingredient amount, is preferably within a range from 0.5 to 20.0% by mass relative to the total mass of the pretreatment agent.

In those cases where the aqueous inkjet ink is coated on the substrate which has been treated with a coagulant, the color development of the printed matter can be further enhanced due to aggregation of the colorant component in the ink.

The coagulant may be a cationic resin, a polyvalent metal salt, an organic acid, an inorganic acid, a salt of an inorganic acid or the like, or a combination thereof. The cationic resin may be, for example, a cationic water-soluble resin, a cationic water-dispersible resin, or a combination thereof.

The total amount of the coagulant including the amounts of a cationic resin, a polyvalent metal salt, an organic acid, and an inorganic acid is preferably within a range from 1 to 50% by mass, more preferably from 3 to 20% by mass, relative to the total mass of the pretreatment agent.

The pretreatment agent preferably contains water as an aqueous solvent. The pretreatment agent may contain water as the main solvent.

The pretreatment agent may contain a water-soluble organic solvent from the viewpoint of viscosity adjustment and moisturizing effect.

As for water and water-soluble organic solvents, those described above for the ink can be used.

Besides the components as described above, the pretreatment agent may optionally contain a wetting agent (moisturizer), a surface tension adjuster (penetrant), an antifoaming agent, a fixing agent, an antioxidant, a preservative, a pH adjuster, and/or the like.

[Method for Producing Printed Matter]

One example of methods for producing a printed matter is described below.

The method for producing a printed matter may include, for example, forming an image on a substrate using an aqueous inkjet ink. The above-described aqueous inkjet ink can be used as the aqueous inkjet ink.

The method may also include treating the substrate with a pretreatment agent prior to the formation of the image using the aqueous inkjet ink.

Prior to the formation of the image on the substrate using the aqueous inkjet ink, a white coating may be applied to the substrate using a white ink. This enables color development of the ink coating film formed with the aqueous inkjet ink to be further enhanced. There are no particular limitations on the white ink. An ink having an ordinary formulation and containing a white pigment as a colorant may be used as the white ink. An aqueous inkjet ink that is an ink according to one embodiment and that contains a white pigment as a colorant may be used as the white ink.

As a method for forming an image on the substrate using an aqueous inkjet ink, an inkjet printing method can be used. The inkjet printing method may enable on-demand image formation to be performed easily and freely without contacting a substrate.

The ink jet printing apparatus may be of any of various systems such as a piezo system, an electrostatic system, or a thermal system. The ink jet printing apparatus may jet an ink from an inkjet head based on a digital signal to allow the jetted ink droplets to adhere to the substrate.

The obtained printed matter is preferably subjected to a heat treatment for removal of the volatile fraction. The heat treatment temperature is preferably within a range from 25° C. to 150° C., and more preferably from 50° C. to 120° C.

In one embodiment, since the ink contains the urethane-based resin (A) and the (meth)acrylic-based resin (B), by subjecting the obtained printed matter to a heat treatment, the resin component in the ink can be melted or softened to form a uniform coating film. As a result, the strength and the flexibility of the ink coating film can be further enhanced, and the durability and the workability of the ink coating film can be further enhanced.

When the (meth)acrylic-based resin (B) is used, the durability of the ink coating film can be further enhanced by additionally using a crosslinking agent having crosslinking properties for causing crosslinking by an external stimulus such as heat, together with the (meth)acrylic-based resin (B). Such a (meth)acrylic-based resin (B) preferably has a structure having a carboxy group, a glycidyl group, a ketone group or the like as a functional group. Examples of the crosslinking agents which can be preferably used in combination with the (meth)acrylic-based resin (B) include (poly)carbodiimide compounds, (poly)isocyanate compounds, epoxy compounds, silyl compounds, oxazoline compounds, and hydrazine compounds.

A step of post-treating the substrate to form an overcoat layer may further be provided after the application of the ink onto the substrate. The substrate may be post-treated by, for example, applying a post-treatment agent to the substrate. Since the ink according to one embodiment contains a resin component, an ink coating film having sufficient strength and flexibility can be obtained by forming a resin film only with the ink, and an ink coating film having further enhanced durability and workability can be obtained. An overcoat layer, however, may be further provided depending on the application.

As the post-treatment agent, for example, a post-treatment liquid containing a resin capable of forming a film and an aqueous or oily medium can be used.

According to one embodiment, an ink set including an aqueous inkjet ink and a pretreatment agent can be provided. With respect to the aqueous inkjet ink and the pretreatment agent, the aqueous inkjet ink as described above and the pretreatment agent as described above can be respectively used. The ink set may further include one or more other inks and/or one or more post-treatment agents.

The aqueous inkjet ink according to one embodiment can be applied to either a permeable substrate or a substrate having low permeability. The substrate having low permeability may be any one of a low permeability substrate and a non permeable substrate. In particular, in those cases where the aqueous inkjet ink according to one embodiment is used with respect to the substrate having low permeability, the strength and the flexibility of the ink coating film can be further improved, and the durability and the workability of the ink coating film can be further enhanced.

The substrate having low permeability is a substrate into the interior of which a liquid is little able to permeate, and, specifically, when an ink is applied to the surface of the substrate, the most part of the liquid components in the ink remains on the surface the substrate.

Examples of the substrates having low permeability include metal substrates, glass substrates, resin substrates and ceramic substrates. Examples of the metal substrates include a metal plate of aluminum, iron, copper, titanium, tin, chromium, cadmium, an alloy (for example, stainless steel, steel, or the like). Examples of the glass substrates include flat glass of borosilicate glass, quartz glass, soda lime glass. Examples of the resin substrates include resin sheets such as PET films, OHT sheets, polyester sheets, and polypropylene sheets, and acrylic plates. Examples of the ceramic substrates include molded products of alumina, zirconia, steatite, silicon nitride.

These substrates may be provided with a plating layer, a metal oxide layer, a resin layer, or the like, or may be subjected to a surface treatment using a surfactant, a corona treatment, or the like. The aqueous inkjet ink according to one embodiment can exhibit the effect even when the ink is applied to an untreated substrate.

Examples of the permeable substrates include printing papers such as plain papers, coated papers, and specialty papers; fabrics such as woven fabrics and non-woven fabrics; porous building materials such as for humidity control, sound absorption, heat insulation; wooden substrates, concrete substrates, and porous materials.

A printed matter according to one embodiment may include a substrate and an ink image layer formed on the substrate, and the ink image layer may contain or may be formed with a water-dispersible polyether-type aliphatic urethane-based resin (A), a water-dispersible acrylic-based resin (B), an acetylene glycol-based surfactant (C) having an HLB value of not more than 10.0, and a colorant.

This may enable a printed matter with a printed image having excellent durability and workability to be provided. Further, according to one embodiment, a printed matter with an image having excellent image quality can be provided.

In particular, in those cases where a decorative article is produced using a rigid substrate such as a metal substrate as the substrate, since the ink coating film has flexibility, when the printing portion having a printed image is subjected to processing such as bending or the like, cracking and whitening of the printed image in the processed portion can be prevented.

As to the printed matter, the details of the substrate, the urethane-based resin (A), the (meth)acrylic-based resin (B), the surfactant (C), and the colorant are as described above.

[Ink Set]

An ink set according to one of embodiments is described below. In the following description, the portions not specifically described are as described for the aqueous inkjet ink and the method for producing the printed matter as described above, and the description of the portions common to both the ink set and the aqueous inkjet ink and/or method for producing a printed matter as described above may be omitted.

An ink set according to one embodiment includes an aqueous inkjet ink and a maintenance liquid, in which the aqueous inkjet ink contains a water-dispersible polyether-type aliphatic urethane-based resin (A), a water-dispersible (meth)acrylic-based resin (B), an acetylene glycol-based surfactant (C) having an HLB value of not more than 10.0, a colorant, and water, and the maintenance liquid contains an acetylene glycol-based surfactant (C′) having an HLB value of not more than 10.0, and at least 30% by mass, relative to the total mass of the maintenance liquid, of glycerol.

According to the ink set according to one embodiment, a printed matter with a printed image having excellent durability and workability can be provided, and continuous jetting performance of the aqueous inkjet ink can be improved. Further, according to the ink set according to one embodiment, a printed matter with a printed image having excellent image uniformity can be provided.

The maintenance liquid is a liquid for cleaning the members, such as the nozzle surface of the nozzle head and the interior of the nozzle head, in the inkjet printer. Since inks may easily adhere to the nozzle surface near the jetting port of the nozzle, the interior of the head, and the like, then the maintenance liquid can be used to remove ink stains by cleaning. In those cases where an ordinary aqueous ink is used, even when water is used as the maintenance liquid, the ink may be removed by mixing of the water and the ink, thus enabling the cleaning. Since an acetylene glycol surfactant having a low HLB value has lower solubility in water than that of a surfactant having a high HLB value, if, after printing with an aqueous ink containing the acetylene glycol surfactant having a low HLB value, the nozzle surface, the interior of the head, and the like are cleaned with only water, the surfactant in the ink may remain on the nozzle surface, the wall surfaces of the interior of the inkjet head, and the like, by being adsorbed thereto, without being washed away. When the amount of such adsorbed matter increases, the jetting ports of the nozzles may be blocked, and, as a result, the jetting reliability such as the image uniformity and the continuous jetting performance may be lowered.

In the cleaning of the nozzle surface, if the combination of the ink and the maintenance liquid are not sufficiently miscible with each other, the nozzle surface cannot be sufficiently cleaned, and, as a result, the jetting port of the nozzles may be blocked and jetting faults may occur. By forming a mixture in which the ink and the maintenance liquid are stably mixed, on the nozzle surface, the removal of the ink may be promoted, and the nozzle surface can be appropriately cleaned.

The cleaning efficiency can be further enhanced by using a maintenance liquid that is miscible with the aqueous ink according to one embodiment in an arbitrary ratio to the aqueous ink. Further, when the mixed liquid containing the ink and the maintenance liquid that are miscible with each other is concentrated on the nozzle surface, if the miscibility between the ink and the maintenance liquid is maintained, the generation of foreign matter in the concentrated mixed liquid can be suppressed. For example, even when the maintenance liquid is applied to the nozzle surface in a state where the ink adhered to the nozzle surface has been concentrated, or even when the maintenance liquid that has been applied to the nozzle surface is concentrated by volatilization of the volatile component of the maintenance liquid, the occurrence of aggregation of the pigment of the ink, the resin emulsion or the like can be suppressed in the concentrated mixture.

The maintenance liquid preferably contains an acetylene glycol-based surfactant having a low HLB value as a component common to both the ink and the maintenance liquid. This surfactant is preferably contained in the maintenance liquid in a dissolved state. Even when the maintenance liquid is mixed with the ink at an arbitrary ratio on the nozzle surface, the maintenance liquid may enable the stability of the mixed liquid to be maintained, and may prevent generation of aggregates of the ink-derived pigment, resin emulsion, or the like. As a result, the image uniformity and the continuous jetting performance can be enhanced.

Further, with the incorporation of glycerol in the maintenance liquid, in an amount of at least 30% by mass relative to the total mass of the maintenance liquid, the moisture retaining property of the maintenance liquid can be enhanced, and even if the maintenance liquid alone or the mixed liquid of the maintenance liquid and the ink is opened to the atmosphere, the generation of aggregates due to rapid evaporation of water can be suppressed. Further, in those cases where the maintenance liquid contains glycerol, since the ratio of water in the maintenance liquid becomes relatively small, the ratio of water also becomes smaller in the mixed liquid of the ink and the maintenance liquid, and the acetylene glycol-based surfactant having a low HLB value can be maintained in a dissolved state in the mixture. As a result, the image uniformity and the continuous jetting performance can be enhanced.

The above-described aqueous inkjet ink can be used as the aqueous inkjet ink provided in the ink set. The details of the aqueous inkjet ink are as described above.

The maintenance liquid provided in the ink set may contain an acetylene glycol-based surfactant (C′) having an HLB value of not more than 10.0 and glycerol. Hereafter, the acetylene glycol-based surfactant (C′) having an HLB value of not more than 10.0 is also referred to as the surfactant (C′).

Examples of the acetylene glycol-based surfactant (C′) that may be contained in the maintenance liquid include those described for the acetylene glycol-based surfactant (C) contained in the aqueous inkjet ink. The type of the acetylene glycol-based surfactant of the maintenance liquid may be the same as or different from that of the acetylene glycol-based surfactant of the aqueous inkjet ink. The maintenance liquid and the aqueous inkjet ink may each contain one or two or more acetylene glycol-based surfactants. When two or more acetylene glycol-based surfactants are contained in at least one of the maintenance liquid and the aqueous inkjet ink, the acetylene glycol-based surfactants may be partially or entirely the same or may be entirely different between the maintenance liquid and the aqueous inkjet ink.

The acetylene glycol-based surfactant (C) contained in the aqueous inkjet ink and the acetylene glycol-based surfactant (C′) contained in the maintenance liquid preferably contain the same component. In this case, when the maintenance liquid and the ink are mixed at the nozzle surface during the maintenance operation, the stability of the mixed liquid can be further enhanced, and the continuous jetting performance can be enhanced.

The amount of the surfactant (C′), expressed as an active ingredient amount, is preferably at least 0.1% by mass, more preferably at least 0.5% by mass, and still more preferably 1% by mass or greater, relative to the total mass of the maintenance liquid. This further ensures that the maintenance liquid that exhibits miscibility with the aqueous ink containing the acetylene glycol-based surfactant having a low HLB value and enables the generation of foreign matter to be suppressed can be provided. This maintenance liquid can more efficiently remove the ink stains that include the surfactant and are adhered to the nozzle surface, and the image uniformity and the continuous jetting performance can be enhanced.

The amount of the surfactant (C′), expressed as an active ingredient amount, is preferably not more than 10% by mass, more preferably not more than 5% by mass, and still more preferably 3% by mass or less, relative to the total mass of the maintenance liquid.

For example, the amount of the surfactant (C′) is preferably within a range from 0.1 to 10% by mass, more preferably from 0.5 to 5% by mass, and still more preferably from 1 to 3% by mass, relative to the total mass of the maintenance liquid.

The maintenance liquid may contain one or more surfactants other than the surfactant (C′) described above. As the surfactant other than the surfactant (C′), a nonionic surfactant, an anionic surfactant, or a combination thereof may be preferably used, and a nonionic surfactant is more preferably used. Examples of the surfactants other than the surfactant (C′) include those described for the surfactant other than the surfactant (C) for the aqueous inkjet ink described above.

In those cases where the surfactant other than the surfactant (C′) is contained in the maintenance liquid, the amount of the surfactant (C′), expressed as an active ingredient amount, is preferably at least 50% by mass, more preferably at least 80% by mass, and still more preferably 90% by mass or greater, relative the total mass of the surfactant.

The maintenance liquid may contain an aqueous solvent. The aqueous medium may be a water-soluble organic solvent, water, or a combination thereof.

Examples of the water-soluble organic solvents contained in the maintenance liquid include those described for the water-soluble organic solvent for the aqueous inkjet ink as described above.

Among water-soluble organic solvents, a glycerol, a glycol, a glycol ether, or a combination thereof may be preferably used, and a glycerol may be more preferably used. Specific examples of glycerols include glycerol. These water-soluble organic solvents have better compatibility with water and also have good affinity with the acetylene alcohol-based surfactants (C′).

The maintenance liquid preferably contains glycerol.

The amount of glycerol is preferably at least 20% by mass, and more preferably 30% by mass or greater, relative the total mass of the maintenance liquid. In this range, the moisture retaining property of the maintenance liquid can be further enhanced, and the evaporation of water from the cleaning surface can be further reduced. For example, even when the maintenance liquid alone or the mixed liquid of the maintenance liquid and the ink is opened to the atmosphere on the cleaning surface, generation of aggregates due to rapid evaporation of water can be suppressed, and the image uniformity and the continuous jetting performance can be enhanced.

The amount of glycerol is preferably not more than 50% by mass, is more preferably not more than 40% by mass, and may be 35% by mass or less, relative to the total mass of the maintenance liquid. When the amount of glycerol relative to the total mass of the maintenance liquid is within such a range, rapid thickening of the maintenance liquid upon evaporation of water can be suppressed.

For example, the amount of glycerol is preferably within a range from 20 to 50% by mass, more preferably from 30 to 40% by mass, and still more preferably from 30 to 35% by mass, relative to the total mass of the maintenance liquid.

It is preferable to use a low-polarity solvent, among water-soluble organic solvents. A surfactant having a low HLB value tends to exhibit poor solubility in an aqueous solvent, and may float in the maintenance liquid. In such a case, the solubility of the surfactant having a low HLB value can be enhanced by adding a low-polarity solvent to the maintenance liquid. Examples of the low-polarity solvents that may be preferably used include diethylene glycol monoethyl ether, diethylene glycol monomethyl ether, diethylene glycol monobutyl ether, propylene glycol monomethyl ether, propylene glycol monoethyl ether, triacetin, 3,5,5-trimethyl-2-cyclohexene-1-one, and 2-pyrrolidone.

The amount of the water-soluble organic solvent, relative to the total mass of the maintenance liquid, may be within a range from 20 to 80% by mass, more preferably from 30 to 60% by mass, and still more preferably from 30 to 50% by mass, from the viewpoints of viscosity adjustment and moisturizing effect.

The amount of the low-polarity water-soluble organic solvent, relative to the total mass of the maintenance liquid, is preferably within a range from 1 to 20% by mass, more preferably from 1 to 10% by mass, and still more preferably from 2 to 3% by mass.

The maintenance liquid may contain water together with a water-soluble organic solvent.

The amount of water, relative to the total mass of the maintenance liquid, is preferably not more than 60% by mass, and more preferably 50% by mass or less. Since the surfactant having a low HLB value tends to easily precipitate when the amount of water increases, the precipitation of the surfactant having a low HLB value can be suppressed by decreasing the amount of water.

The amount of water is preferably at least 30% by mass, and more preferably 40% by mass or greater, relative to the total mass of the maintenance liquid. This further ensures that the aqueous component contained in the aqueous ink can be dissolved or dispersed, thereby removing the aqueous component of the aqueous ink.

For example, the amount of water is preferably within a range from 30 to 60% by mass, more preferably from 40 to 60% by mass, and still more preferably from 40 to 50% by mass, relative to the total mass of the maintenance liquid.

In addition to the above components, the maintenance liquid may optionally contain a wetting agent (moisturizer), a surface tension adjuster (penetrant), an antifoaming agent, a pH adjuster, an antioxidant, a preservative, or the like. Examples of such optional components include those described for the optional components for the above-described aqueous inkjet ink.

The viscosity of the maintenance liquid at 23° C. is preferably within a range from 1 to 200 mPa·s, and more preferably from 3 to 100 mPa·s. The viscosity of the maintenance liquid can be measured using a rotation viscometer.

The pH of the maintenance liquid is preferably from 5.5 to 9.0. In this range, generation of aggregates during the cleaning of the head surface can be further suppressed, the nozzle blockage can be further prevented, and continuous jetting performance can be further enhanced.

The surface tension of the maintenance liquid is preferably within a range from 20 to 50 mN/m, and more preferably from 25 to 40 mN/m.

The method for producing the maintenance liquid is not particularly limited. For example, a desired maintenance liquid can be obtained by appropriately mixing together the components. The obtained composition may be filtered through a filter or the like.

One example of a method of performing a maintenance operation using an ink set according to one embodiment is described below.

The maintenance operation of the inkjet head can be performed in the inkjet printing apparatus in order to reduce the ink jetting faults in the inkjet head.

Examples of the maintenance operations include a method in which a maintenance liquid is applied to the nozzle surface, a method in which a maintenance liquid is applied to the nozzle surface and the nozzle surface is wiped with a wiper, and a method in which the nozzle surface is wiped with a wiper in a state in which a maintenance liquid is applied to the wiper. According to one embodiment, in any of these methods, the stability of the mixed liquid of the ink and the maintenance liquid on the nozzle surface can be enhanced, and the ink stains can be efficiently removed from the nozzle surface.

Since the wiper comes into contact with the head, from the viewpoint of suppressing nozzle damages, a material having a higher elasticity than that of hard materials is suitable as the material of the wiper. Examples of such materials of the wiper include silicone rubbers and fluoro rubbers. Since the wiper frequently comes into contact with the maintenance liquid and the ink, the wiper is preferably durable against these liquids such that deformation or the like is unlikely to be caused by these liquids.

With respect to the timing of the maintenance operation, the maintenance operation may be performed immediately before the printing, immediately after the printing, or both of them. The maintenance operation may be performed after each certain number of printings. The maintenance operation may be performed, for example, when the contamination of the nozzle surface is detected by a sensor or the like.

For the maintenance operation, a maintenance mechanism, such as a maintenance liquid storage part and a wiper, may be provided in the inkjet printing apparatus. Examples of other methods of the maintenance operation include a method in which the stains on the nozzle surface are manually wiped off using the maintenance liquid when the nozzle surface gets dirty, and a method in which the nozzle surface is immersed in the maintenance liquid to dissolve and remove the ink from the nozzle surface.

The maintenance liquid is not only suitable for cleaning the nozzle surface, but also applicable to other members such as the interior of the nozzle head, the path for conveyance of the substrate, the ink tank, and the casing.

### EXAMPLES

The present invention is described below in further detail based on a series of examples, but the present invention is not limited to only these examples. Unless specifically stated otherwise, “%” represents “% by mass”, and “−” in the table indicates that the material is not added.

### Production Example A

### <Preparation of Pigment Dispersion>

Table 1 shows the formulation of the pigment dispersion.

The components were premixed together according to the formulation shown in the table. Thereafter, a 500 mL PP (polypropylene) container was charged with 300 g of the mixture obtained as described above, and zirconia beads having a diameter of Φ0.5 mm were added such that the total amount of the contents in the PP container was about 90% of the container. The PP container was set in a rocking mill (manufactured by Seiwa Giken Co., Ltd.) and a dispersion treatment was performed for 2 hours, and, then, zirconia beads were separated from the obtained dispersion liquid, thus obtaining a pigment dispersion.

The components used were as follows.

Magenta pigment: “FASTOGEN SUPER MAGENTA RGT” manufactured by DIC Corporation.

Acrylic-based dispersant: “DISPERBYK-190” manufactured by BYK, active ingredient content: 40%.

pH adjuster: “TEA (triethanolamine)” manufactured by FUJIFILM Wako Pure Chemical Corporation.

Preservative: “PROXEL XL2 (S)” manufactured by Lonza.

TABLE 1
Formulation of Pigment Dispersion

| Unit: g | Magenta dispersion |
|---|---|
| Magenta pigment | 60 |
| Acrylic-based dispersant | 60 |
| Ion-exchanged water | 176 |
| pH adjuster | 3 |
| Preservative | 1 |
| Total (g) | 300 |

<Preparation of Ink>

The formulations of the inks for Examples and Comparative Examples are shown in Tables 2 to 5. In each table, the blend amount of the magenta pigment dispersion represents the total amount of the pigment dispersion. Each of the blend amounts shown for various resin emulsions represents the total amount of the resin emulsion. The pigment content of the pigment dispersion and the solid fraction contents for the various resin emulsions shown in the table are “% by mass” values. The solvent contained in the pigment dispersion and the solvent contained in the resin emulsions shown in the table are mainly water.

The components were mixed together according to the ink formulations shown in the tables, and the obtained mixture was then filtered through a membrane filter having a pore diameter of 3μm to obtain an ink.

The components used were as follows.

(Component 1: Pigment Dispersion)

Magenta dispersion: prepared by the method as described above, pigment content: 20%.

(Component 2: Urethane-based resin emulsion)

Polyether-type aliphatic urethane-based resin (1): “TAKELAC W-6020”manufactured by Mitsui Chemicals, Inc., solid fraction content: 30.0%.

Polyether-type aliphatic urethane-based resin (2): “PERMARIN UA-200” manufactured by Sanyo Chemical Industries, Ltd., solid fraction content: 30.0%.

Polyether-type aliphatic urethane-based resin (3): “TAKELAC W-5661” manufactured by Mitsui Chemicals, Inc., solid fraction content: 35.0%.

Polyether-type aromatic urethane-based resin “NeoRez R-9404” manufactured by DSM, solid fraction content: 31.0%.

Polyester-type aliphatic urethane-based resin: “ADEKA BONTIGHTER HUX-370” manufactured by ADEKA CORPORATION, solid fraction content: 33.0%.

Polycarbonate-type aliphatic urethane-based resin: “UCOAT UX-485” manufactured by Sanyo Chemical Industries, Ltd., solid fraction content: 40.0%.

The urethane-based resin emulsions as listed the above are all anionic. The components (2a) in the tables represent polyether-type aliphatic urethane-based resin emulsions, and the components (2b) in the tables represent comparative urethane-based resin emulsions.

(Component 3: Acrylic-based resin emulsion)

Styrene acrylic-based resin: “Mowinyl 966 A” manufactured by Japan Coating Resin Corporation, solid fraction content: 45.0%.

Acrylic-based resin: “Mowinyl 9760” manufactured by Japan Coating Resin Corporation, solid fraction content: 19.5%.

The acrylic-based resin emulsions as listed above are all anionic.

(Component 4: Water-soluble organic solvent)

Glycerol, 1,3-propanediol, diethylene glycol, propylene glycol and diethylene glycol monoethyl ether shown in the tables are all available from FUJIFILM Wako Pure Chemical Corporation.

(Component 5: Surfactant)

Acetylene glycol (HLB: 4.0): “SURFYNOL 420” manufactured by Nisshin Chemical Industry Co., Ltd.

Acetylene glycol (HLB: 8.1): “SURFYNOL 440” manufactured by Nisshin Chemical Industry Co., Ltd.

Acetylene glycol (HLB: 13.2): “OLFINE E 1010” manufactured by Nisshin Chemical Industry Co., Ltd.

Acetylene glycol (HLB: 17.1): “SURFYNOL 485” manufactured by Nisshin Chemical Industry Co., Ltd.

The surfactants as listed above are all acetylene glycol-based surfactants and are all nonionic. The surfactants as listed above all have an active ingredient amount of 100% by mass. Components (5a) in the table represent surfactants having an HLB value of not more than 10.0, and components (5b) represent surfactants having an HLB value of greater than 10.0.

The HLB value of the surfactant is a numerical value obtained in accordance with the Griffin method and calculated by the following formula (1) based on the molecular structure of the surfactant.

HLB value=20×(formula weight of hydrophilic part)/(molecular weight of surfactant) Formula (1)

The swelling ratio of the urethane-based resin emulsion was measured according to the following procedure.

With respect to the combination of the urethane-based resin emulsion and the surfactant of the measurement object ink, the ratio by mass of swelling of the urethane-based resin caused in a state where the urethane-based resin was immersed in the surfactant was determined. When two surfactants were contained in the measurement objet ink, for the measurement of the swelling ratio, the two surfactants were mixed together such that the mass ratio of these two surfactants in the mixture for the measurement of the swelling ratio was the same as the mass ratio of these two surfactants in the measurement object ink, and the thus obtained mixture was used as the surfactant for the measurement of the swelling ratio.

The urethane-based resin emulsion used for preparing the measurement object ink was placed in a glass Petri dish having a diameter of 5 cm, in an amount, expressed as a solid fraction amount, of 1.5 g. This Petri dish was then placed in a thermal dryer at a temperature of 100° C. to evaporate water from the resin emulsion and dry the resin to obtain a dried film. The thus obtained dried film, which was a test piece, was cut to a size of 1 cm×1 cm, and the mass of the test piece of a size of 1 cm×1 cm was measured. The test piece was then placed in a glass bottle, and 1.0 g of the surfactant of the measurement object ink was added thereto to allow the test piece to be immersed in the surfactant. Twelve (12) hours later, the test piece was taken out from the surfactant, and, then, the surfactant on the surface of the test piece was wiped off. Thereafter, the mass of the test piece was measured. The swelling ratio was calculated by the following formula.

Swelling ratio [%]={((mass of test piece after immersion)−(mass of test piece before immersion))/(mass of test piece before immersion)}×100

<Evaluation Method>

Using each of the thus obtained inks, a decorative article was prepared according to the following procedure, and the following evaluations were performed. The results are shown in Tables 2 to 5.

A white-coated aluminum plate (an aluminum flat plate available from Nikkal Shoukou) was used as the substrate.

The white-coated aluminum plate cut to a size of 10 cm×10 cm was heated in an oven at a temperature of 70° C. for 10 minutes.

Each ink was introduced into an inkjet head of an inkjet printer (Anajet mPower-10 manufactured by Anajet), and a monochromatic photographic image of magenta was printed onto the white-coated aluminum plate in a state where the surface temperature of the heated white-coated aluminum plate was 40° C.

After the printing, the obtained aluminum plate having the photographic image printed thereon was heated and dried in an oven at a temperature of 150° C. for 10 minutes to obtain a decorative article as a printed matter.

(Durability of Printed Image)

The image portion of the decorative article thus obtained was subjected to back and forth rubbing using a steel wool having a bottom area of 9 cm×9 cm with a load of 60 kg/m² and, and a change in the surface of the substrate was observed. The durability of the printed image was evaluated against the following criteria.

AA: no significant change was observed in the image even after 30 back and forth rubbing repetitions.

A: the image became slightly whitish after 30 back and forth rubbing repetitions.

B: stripping of the image occurred after not more than 30 back and forth rubbing repetitions.

C: stripping of the image occurred after not more than ten back and forth rubbing repetitions.

D: stripping of the image occurred after one back and forth rubbing.

(Workability of Printed Image)

The obtained decorative article was bent at 90 degrees by a bender, and the change of the image in the bent portion was observed. The workability of printed images was evaluated against the following criteria.

A: whitening due to minute cracks in the image caused by the bending was not observed.

B: whitening was not observed, but minute cracks detectable with a magnifying glass were observed.

C: whitening was observed.

D: whitening was observed, and stripping of the image from the cracked portion occurred.

(Image Quality of Printed Image)

The image portion of the obtained decorative article was observed with a zoom microscope with respect to the presence or absence of yellowing in the photographic image. The image quality of the printed image was evaluated against the following criteria.

A: no yellowing was observed in the photographic image.

B: slight yellowing was observed in the photographic image.

C: strong yellowing was observed in the photographic image.

TABLE 2
Ink Formulations and Evaluation Results

| | | Example | Example | Example | Example | Example | Example |
|---|---|---|---|---|---|---|---|
| Unit: % by mass | | 1 | 2 | 3 | 4 | 5 | 6 |
| Component | Magenta dispersion: pigment content | 25.0 | 25.0 | 25.0 | 25.0 | 25.0 | 25.0 |
| (1) | 20.0% | | | | | | |
| Component | Polyether-type aliphatic urethane-based | 13.3 | 26.7 | 16.7 | 10.0 | 13.3 | 6.7 |
| (2a) | resin (1): solid fraction content 30.0% | | | | | | |
| | Polyether-type aliphatic urethane-based | — | — | — | — | — | — |
| | resin (2): solid fraction content 30.0% | | | | | | |
| | Polyether-type aliphatic urethane- | — | — | — | — | — | — |
| | based resin (3): solid fraction content | | | | | | |
| | 35.0% | | | | | | |
| Component | Polyether-type aromatic urethane-based | — | — | — | — | — | — |
| (2b) | resin: solid fraction content 31.0% | | | | | | |
| | Polyester-type aliphatic urethane-based | — | — | — | — | — | — |
| | resin: solid fraction content 33.0% | | | | | | |
| | Polycarbonate-type aliphatic urethane- | — | — | — | — | — | — |
| | based resin: solid fraction content | | | | | | |
| | 40.0% | | | | | | |
| Component | Styrene-acrylic-based resin: solid | 4.4 | 2.2 | 6.7 | 4.4 | 4.4 | 6.7 |
| (3) | fraction content 45.0% | | | | | | |
| | Acrylic-based resin: solid fraction | — | — | — | — | — | — |
| | content 19.5% | | | | | | |
| Component | Glycerol | 15.0 | 15.0 | 15.0 | 15.0 | 15.0 | 20.0 |
| (4) | 1,3-propanediol | 12.0 | 11.0 | 10.0 | 12.0 | 12.0 | 5.0 |
| | Diethylene glycol | 10.0 | 10.0 | 10.0 | 10.0 | 10.0 | 18.0 |
| | Propylene glycol | 5.0 | 5.0 | 5.0 | 5.0 | 5.0 | — |
| | Diethylene glycol monoethyl ether | 3.0 | 3.0 | 3.0 | 3.0 | 3.0 | 5.0 |
| Component | Acetylene glycol (HLB: 4.0) | — | — | 1.0 | — | | 0.5 |
| (5a) | Acetylene glycol (HLB: 8.1) | 1.0 | 1.0 | 1.0 | 1.0 | 1.0 | — |
| Component | Acetylene glycol (HLB: 13.2) | — | — | — | — | 0.5 | — |
| (5b) | Acetylene glycol (HLB: 17.1) | — | — | — | — | — | — |

| | | | | | | |
|---|---|---|---|---|---|---|
| Water | 11.3 | 1.1 | 6.6 | 14.6 | 10.8 | 13.1 |
| Total (% by mass) | 100.0 | 100.0 | 100.0 | 100.0 | 100.0 | 100.0 |
| Urethane resin emulsion amount | 4.0 | 8.0 | 5.0 | 3.0 | 4.0 | 2.0 |
| (solid fraction amount) (% by mass) | | | | | | |
| Polyether-type aliphatic urethane-based resin | 4.0 | 8.0 | 5.0 | 3.0 | 4.0 | 2.0 |
| emulsion amount (solid fraction amount) | | | | | | |
| (% by mass) | | | | | | |
| Acrylic-based resin emulsion amount | 2.0 | 1.0 | 3.0 | 2.0 | 2.0 | 3.0 |
| (solid fraction amount) (% by mass) | | | | | | |
| Resin emulsion total amount | 6.0 | 9.0 | 8.0 | 5.0 | 6.0 | 5.0 |
| (solid fraction amount) (% by mass) | | | | | | |
| Amount of surfactant having HLB of not more | 1.0 | 1.0 | 2.0 | 1.0 | 1.0 | 0.5 |
| than 10.0 (% by mass) | | | | | | |
| Swelling ratio of urethane-based resin emulsion (%) | 30.0 | 30.0 | 45.0 | 30.0 | 20.0 | 30.0 |
| Durability of printed image | AA | AA | AA | AA | AA | A |
| Workability of printed image | A | A | A | A | A | A |
| Image quality of printed image | A | A | A | A | A | A |

TABLE 3
Ink Formulations and Evaluation Results

| | | Example | Example | Example | Example | Example | Example |
|---|---|---|---|---|---|---|---|
| Unit: % by mass | | 7 | 8 | 9 | 10 | 11 | 12 |
| Component | Magenta dispersion: pigment content | 25.0 | 25.0 | 25.0 | 25.0 | 25.0 | 25.0 |
| (1) | 20.0% | | | | | | |
| Component | Polyether-type aliphatic urethane-based | — | — | 3.3 | — | — | — |
| (2a) | resin (1): solid fraction content 30.0% | | | | | | |
| | Polyether-type aliphatic urethane-based | — | 6.7 | — | — | 8.3 | 6.7 |
| | resin (2): solid fraction content 30.0% | | | | | | |
| | Polyether-type aliphatic urethane-based | 11.4 | — | — | 7.1 | — | — |
| | resin (3): solid fraction content 35.0% | | | | | | |
| Component | Polyether-type aromatic urethane-based | — | — | — | — | — | — |
| (2b) | resin: solid fraction content 31.0% | | | | | | |
| | Polyester-type aliphatic urethane-based | — | — | — | — | — | — |
| | resin: solid fraction content 33.0% | | | | | | |
| | Polycarbonate-type aliphatic urethane- | — | — | — | — | — | — |
| | based resin: solid fraction content | | | | | | |
| | 40.0% | | | | | | |
| Component | Styrene-acrylic-based resin: solid | — | 2.2 | — | — | — | — |
| (3) | fraction content 45.0% | | | | | | |
| | Acrylic-based resin: solid fraction | 5.1 | — | 5.1 | 2.6 | 2.6 | 5.1 |
| | content 19.5% | | | | | | |
| Component | Glycerol | 15.0 | 15.0 | 15.0 | 15.0 | 15.0 | 15.0 |
| (4) | 1,3-propanediol | 10.0 | 12.0 | 10.0 | 10.0 | 10.0 | 10.0 |
| | Diethylene glycol | 15.0 | 10.0 | 20.0 | 20.0 | 20.0 | 20.0 |
| | Propylene glycol | — | 5.0 | — | — | — | — |
| | Diethylene glycol monoethyl ether | — | 3.0 | — | — | — | — |
| Component | Acetylene glycol (HLB: 4.0) | 0.5 | — | — | — | — | — |
| (5a) | Acetylene glycol (HLB: 8.1) | 0.5 | 1.0 | 1.0 | 1.0 | 1.0 | 0.3 |
| Component | Acetylene glycol (HLB: 13.2) | — | — | — | — | — | — |
| (5b) | Acetylene glycol (HLB: 17.1) | — | — | — | — | — | — |

| | | | | | | |
|---|---|---|---|---|---|---|
| Water | 17.5 | 20.1 | 20.6 | 19.3 | 18.1 | 17.9 |
| Total (% by mass) | 100.0 | 100.0 | 100.0 | 100.0 | 100.0 | 100.0 |
| Urethane resin emulsion amount (solid fraction | 4.0 | 2.0 | 1.0 | 2.5 | 2.5 | 2.0 |
| amount) (% by mass) | | | | | | |
| Polyether-type aliphatic urethane-based resin | 4.0 | 2.0 | 1.0 | 2.5 | 2.5 | 2.0 |
| emulsion amount (solid fraction amount) | | | | | | |
| (% by mass) | | | | | | |
| Acrylic-based resin emulsion amount (solid | 1.0 | 1.0 | 1.0 | 0.5 | 0.5 | 1.0 |
| fraction amount) (% by mass) | | | | | | |
| Resin emulsion total amount (solid fraction | 5.0 | 3.0 | 3.5 | 3.0 | 3.0 | 3.0 |
| amount) (% by mass) | | | | | | |
| Amount of surfactant having HLB of not more | 1.0 | 1.0 | 1.0 | 1.0 | 1.0 | 0.3 |
| than 10.0 (% by mass) | | | | | | |
| Swelling ratio of urethane-based resin emulsion | 120.0 | 9.0 | 30.0 | 150.0 | 9.0 | 9.0 |
| (%) | | | | | | |
| Durability of printed image | A | A | A | A | A | A |
| Workability of printed image | A | B | B | B | B | B |
| Image quality of printed image | A | A | A | A | A | A |

TABLE 4
Ink Formulations and Evaluation Results

| | | Comparative | Comparative | Comparative | Comparative |
|---|---|---|---|---|---|
| Unit: % by mass | | Example 1 | Example 2 | Example 3 | Example 4 |
| Component | Magenta dispersion: pigment content | 25.0 | 25.0 | 25.0 | 25.0 |
| (1) | 20.0% | | | | |
| Component | Polyether-type aliphatic urethane-based | — | — | — | 10.0 |
| (2a) | resin (1): solid fraction content 30.0% | | | | |
| | Polyether-type aliphatic urethane-based | — | — | — | — |
| | resin (2): solid fraction content 30.0% | | | | |
| | Polyether-type aliphatic urethane-based | — | — | — | — |
| | resin (3): solid fraction content 35.0% | | | | |
| Component | Polyether-type aromatic urethane-based | — | — | 9.7 | — |
| (2b) | resin: solid fraction content 31.0% | | | | |
| | Polyester-type aliphatic urethane-based | 9.1 | — | — | — |
| | resin: solid fraction content 33.0% | | | | |
| | Polycarbonate-type aliphatic urethane- | — | 7.5 | — | — |
| | based resin: solid fraction content 40.0% | | | | |
| Component | Styrene-acrylic-based resin: solid | 4.4 | 4.4 | 4.4 | — |
| (3) | fraction content 45.0% | | | | |
| | Acrylic-based resin: solid fraction | — | — | — | — |
| | content 19.5% | | | | |
| Component | Glycerol | 10.0 | 10.0 | 10.0 | 15.0 |
| (4) | 1,3-propanediol | — | — | — | 12.0 |
| | Diethylene glycol | 20.0 | 20.0 | 20.0 | 10.0 |
| | Propylene glycol | — | — | — | 5.0 |
| | Diethylene glycol monoethyl ether | — | — | — | 3.0 |
| Component | Acetylene glycol (HLB: 4.0) | — | — | 0.5 | — |
| (5a) | Acetylene glycol (HLB: 8.1) | 1.0 | 1.0 | — | 1.0 |
| Component | Acetylene glycol (HLB: 13.2) | — | — | — | — |
| (5b) | Acetylene glycol (HLB :17.1) | — | — | — | — |

| | | | | |
|---|---|---|---|---|
| Water | 30.5 | 32.1 | 30.4 | 19.0 |
| Total (% by mass) | 100.0 | 100.0 | 100.0 | 100.0 |
| Urethane resin emulsion amount (solid fraction | 3.0 | 3.0 | 3.0 | 3.0 |
| amount) (% by mass) | | | | |
| Polyether-type aliphatic urethane-based resin | 0.0 | 0.0 | 0.0 | 3.0 |
| emulsion amount (solid fraction amount) (% by mass) | | | | |
| Acrylic-based resin emulsion amount (solid | 2.0 | 2.0 | 2.0 | 0.0 |
| fraction amount) (% by mass) | | | | |
| Resin emulsion total amount (solid fraction | 3.0 | 5.0 | 3.0 | 5.0 |
| amount) (% by mass) | | | | |
| Amount of surfactant having HLB of not more | 1.0 | 1.0 | 0.5 | 1.0 |
| than 10.0 (% by mass) | | | | |
| Swelling ratio of urethane-based resin emulsion (%) | 3.6 | 2.5 | 8.4 | 30.0 |
| Durability of printed image | C | B | C | C |
| Workability of printed image | C | C | C | C |
| Image quality of printed image | C | A | B | A |

TABLE 5
Ink Formulations and Evaluation Results

| | | Com- | Com- | Com- | Com- | Com- | Com- |
|---|---|---|---|---|---|---|---|
| | | parative | parative | parative | parative | parative | parative |
| | | Example | Example | Example | Example | Example | Example |
| Unit: % by mass | | 5 | 6 | 7 | 8 | 9 | 10 |
| Component | Magenta dispersion: pigment content | 25.0 | 25.0 | 25.0 | 25.0 | 25.0 | 25.0 |
| (1) | 20.0% | | | | | | |
| Component | Polyether-type aliphatic urethane-based | — | — | — | — | 13.3 | — |
| (2a) | resin (1): solid fraction content 30.0% | | | | | | |
| | Polyether-type aliphatic urethane-based | — | — | — | — | — | 6.7 |
| | resin (2): solid fraction content 30.0% | | | | | | |
| | Polyether-type aliphatic urethane-based | — | — | — | — | — | — |
| | resin (3): solid fraction content 35.0% | | | | | | |
| Component | Polyether-type aromatic urethane based | — | — | 9.7 | — | — | — |
| (2b) | resin: solid fraction content 31.0% | | | | | | |
| | Polyester-type aliphatic urethane-based | 9.1 | — | — | — | — | — |
| | resin: solid fraction content 33.0% | | | | | | |
| | Polycarbonate-type aliphatic urethane- | — | 7.5 | — | — | — | — |
| | based resin: solid fraction 40.0% | | | | | | |
| Component | Styrene-acrylic-based resin: solid | — | — | — | 11.1 | 4.4 | — |
| (3) | fraction content 45.0% | | | | | | |
| | Acrylic-based resin: solid fraction | — | — | — | — | — | 5.1 |
| | content 19.5% | | | | | | |
| Component | Glycerol | 10.0 | 10.0 | 10.0 | 10.0 | 15.0 | 15.0 |
| (4) | 1,3-propanediol | — | — | — | — | 12.0 | 10.0 |
| | Diethylene glycol | 20.0 | 20.0 | 20.0 | 20.0 | 10.0 | 20.0 |
| | Propylene glycol | — | — | — | — | 5.0 | — |
| | Diethylene glycol monoethyl ether | — | — | — | — | 3.0 | — |
| Component | Acetylene glycol (HLB: 4.0) | — | — | 0.5 | — | — | — |
| (5a) | Acetylene glycol (HLB: 8.1) | 1.0 | 1.0 | | 1.0 | — | — |
| Component | Acetylene glycol (HLB: 13.2) | — | — | — | — | 1.0 | — |
| (5b) | Acetylene glycol (HLB: 17.1) | — | — | — | — | — | 1.0 |

| | | | | | | |
|---|---|---|---|---|---|---|
| Water | 34.9 | 36.5 | 34.8 | 32.9 | 11.3 | 17.2 |
| Total (% by mass) | 100.0 | 100.0 | 100.0 | 100.0 | 100.0 | 100.0 |
| Urethane resin emulsion amount (solid fraction | 3.0 | 3.0 | 3.0 | 0.0 | 4.0 | 2.0 |
| amount) (% by mass) | | | | | | |
| Polyether-type aliphatic urethane-based resin | 0.0 | 0.0 | 0.0 | 0.0 | 4.0 | 2.0 |
| emulsion amount (solid fraction amount) (% by | | | | | | |
| mass) | | | | | | |
| Acrylic-based resin emulsion amount (solid | 0.0 | 0.0 | 0.0 | 5.0 | 2.0 | 0.0 |
| fraction amount) (% by mass) | | | | | | |
| Resin emulsion total amount (solid fraction | 3.0 | 5.0 | 3.0 | 5.0 | 5.0 | 5.0 |
| amount) (% by mass) | | | | | | |
| Amount of surfactant having HLB of not more | 1.0 | 1.0 | 0.5 | 1.0 | 0.0 | 0.0 |
| than 10.0 (% by mass) | | | | | | |
| Swelling ratio of urethane-based resin emulsion | 3.6 | 2.5 | 8.4 | — | 9.0 | 4.5 |
| (%) | | | | | | |
| Durability of printed image | D | C | D | C | C | C |
| Workability of printed image | C | C | C | D | C | C |
| Image quality of printed image | C | A | B | A | A | A |

As shown in the tables, in the printed matter of each example, the printed image exhibited excellent durability and workability, and also exhibited good image quality.

It is shown through the examples that favorable results were obtained in each evaluation with the use of the components of one embodiment even if the types of the urethane-based resin (A), the (meth)acrylic-based resin (B), the surfactant (C), and/or the pigment were altered.

It is evident though the examples that when the amount of the urethane-based resin (A) is at least 3% by mass, the durability and workability of the printed image, especially the durability is further improved.

It is evident trough the examples that the durability and the workability of the printed image are further improved when the swelling ratio of the urethane-based resin used in the measurement object ink to the surfactant used in the measurement object ink is within a range from 10 to 100%.

It is evident based on Examples 3, 5 and 7 that two surfactants (C) may be used in combination, and that the surfactant (C) may be combined with one or more other surfactants.

It is evident through the comparative examples that sufficient results cannot be obtained when at least one from among the urethane-based resin (A), the (meth) acrylic-based resin (B), and the surfactant (C) is not contained.

In Comparative Example 1, a polyester-type aliphatic urethane-based resin was used, and the durability and the workability of the printed image were lowered. Further, in Comparative Example 1, the image quality of the printed image was lowered due to the ester linkages of the urethane-based resin.

In Comparative Example 2, a polycarbonate-type aliphatic urethane-based resin was used, and the workability of the printed image was lowered. It is thought that this is because, due to the carbonate linkages of the urethane-based resin, the resin itself is hard but has insufficient flexibility.

In Comparative Example 3, a polyether-type aromatic urethane-based resin was used, and the durability and the workability of the printed image were lowered. Further, in Comparative Example 3, yellowing of the ink coating film occurred due to the aromatic urethane linkages of the urethane-based resin, and the image quality of the printed image was lowered.

In Comparative Example 4, a (meth)acrylic-based resin was not used. Although the deterioration in image quality due to the ink coating film did not occur in Comparative Example 4, the durability and the workability of the printed image were lowered.

Comparative Examples 5 to 7 are comparative examples in which the (meth)acrylic-based resin (B) is not used as compared with Comparative Examples 1 to 3, and the durability of the printed image was further lowered in Comparative Examples 5 to 7.

Comparative Example 8 is a comparative example in which the urethane-based resin is not used, and the durability and the workability of the printed image, especially the workability of the printed image, were lowered.

In Comparative Examples 9 and 10, a surfactant having an HLB value exceeding 10.0 was used, and the durability and the workability of the printed image were lowered. As one of the reasons therefore, it is thought that the interaction between the urethane-based resin (A) and the surfactant (C) having an HLB value of not more than 10.0 could not be obtained and the homogeneity of the ink coating film was lowered.

It is also thought the comparative examples that the above may also be one of the reasons for the deterioration in the durability and the workability of the printed image when the swelling ratio of the urethane-based resin used for the measurement object ink relative to the surfactant used for the measurement object ink is less than 10%.

### Production Example B

<Preparation of Pigment Dispersion>

A magenta pigment dispersion was prepared by the same procedure as in Production Example A.

<Preparation of Ink>

Table 6 shows the ink formulations. The blend amount of the magenta pigment dispersion shown in the table represents the total amount of the pigment dispersion. The blend amount of each resin emulsion represents the total amount of the resin emulsion. The pigment content of the pigment dispersion and the solid fraction content of each resin emulsion shown in the table are in % by mass. The solvent contained in the pigment dispersion and the solvent contained in the resin emulsions shown in the table are mainly water.

The components were mixed together according to the ink formulation shown in the table, and the obtained mixture was then filtered through a membrane filter having a pore diameter of 3 μm to obtain an ink.

The details of the components used are the same as those for the components used for the inks in Production Example A. The HLB values of the surfactants and the swelling ratio values of the urethane-based resin emulsions were determined in the same manner as in Production Example A.

<Preparation of Maintenance Liquid>

Table 7 shows the formulations of the maintenance liquids. The components were mixed together according to the formulation of the maintenance liquid shown in the table, and the obtained mixture was then filtered through a membrane filter having a pore diameter of 3 μm to obtain a maintenance liquid. The pH of the obtained maintenance liquid was measured and the measured value of each maintenance liquids is shown in the table.

All of the water-soluble organic solvents used are available from FUJIFILM Wako Pure Chemical Corporation. The details of the surfactants and the preservatives used are the same as those described for the surfactants and the preservative used for the inks in Production Example A.

<Evaluation Method>

Using each of the thus obtained inks, a decorative article was prepared according to the same procedure as in Production Example A, and the following evaluations were performed. In the following evaluations of the uniformity of the printed image and the continuous jetting performance, with the exception of printing a monochromatic solid image of magenta instead of printing a monochromatic photographic image of magenta, the decorative article having a solid image was prepared by the same operation as that of the preparation of the decorative article having a photographic image in Production Example A.

The durability of the printed image, the workability of the printed image, and the image quality of the printed image were evaluated by the same methods and the same criteria as those in Production Example A described above.

The uniformity of the printed image and the continuous jetting performance were evaluated with respect to the combinations of the ink and the maintenance liquid as shown in Table 8.

(Uniformity of Printed Image)

Printing of a solid image without edges on an aluminum plate having a size of 10 cm×10 cm was performed three times, and thereafter, the nozzle surface of the inkjet head was wiped with a rubber blade which had been immersed in the maintenance liquid. Using the inkjet head in this state, printing of a solid image without edges on an aluminum plate having a size of 10 cm×10 cm was again performed. The image portion of this decorative article, which was obtained by the printing after the wiping of the nozzle surface as described above, was subjected to observation with a zoom microscope to observe the uniformity of the solid image. The uniformity of the printed image was evaluated against the following criteria.

A: a uniform solid image is formed.

B: the solid image is partially uneven.

C: about a half area of the solid image is uneven.

(Continuous Jetting Performance)

Printing of a solid image without edges on an aluminum plate having a size of 10 cm×10 cm was performed continuously ten times, and thereafter, the nozzle surface of the inkjet head was wiped with a rubber blade which had been immersed in the maintenance liquid. Using the inkjet head in this state, printing of a solid image without edges on an aluminum plate having a size of 10 cm x 10 cm was again performed continuously ten times. Thereafter, a nozzle check pattern was printed to check the number of nuzzles which had failed in jetting. The continuous jetting performance was evaluated against the following criteria.

AA: the number of nozzles that failed in jetting is zero.

A: the number of nozzles that failed in jetting is at least one and not more than two.

B: the number of nozzles that failed in jetting is at least three and not more than four.

C: the number of nozzles that failed in jetting is at least five.

TABLE 6
Ink Formulations and Evaluation Results

| Unit: % by mass | | Ink B1 | Ink B2 | Ink B3 |
|---|---|---|---|---|
| Component | Magenta dispersion: pigment content 20.0% | 25.0 | 25.0 | 25.0 |
| (1) | | | | |
| Component | Polyether-type aliphatic urethane-based resin (1): | 13.3 | 26.7 | 16.7 |
| (2a) | solid fraction content 30.0% | | | |
| | Polyether-type aliphatic urethane-based resin (2): | — | — | — |
| | solid fraction content 30.0% | | | |
| | Polyether-type aliphatic urethane-based resin (3): | — | — | — |
| | solid fraction content 35.0% | | | |
| Component | Polyether-type aromatic urethane-based resin: | — | — | — |
| (2b) | solid fraction content 31.0% | | | |
| | Polyester-type aliphatic urethane-based resin: | — | — | — |
| | solid fraction content 33.0% | | | |
| | Polycarbonate-type aliphatic urethane-based resin: | — | — | — |
| | solid fraction content 40.0% | | | |
| Component | Styrene-acrylic-based resin: solid fraction content | 4.4 | 2.2 | 6.7 |
| (3) | 45.0% | | | |
| | Acrylic-based resin: solid fraction content 19.5% | — | — | — |
| Component | Glycerol | 15.0 | 15.0 | 15.0 |
| (4) | 1,3-propanediol | 12.0 | 11.0 | 10.0 |
| | Diethylene glycol | 10.0 | 10.0 | 10.0 |
| | Propylene glycol | 5.0 | 5.0 | 5.0 |
| | Diethylene glycol monoethyl ether | 3.0 | 3.0 | 3.0 |
| Component | Acetylene glycol (HLB: 4.0) | — | — | 1.0 |
| (5a) | Acetylene glycol (HLB: 8.1) | 1.0 | 1.0 | 1.0 |
| Component | Acetylene glycol (HLB: 13.2) | — | — | — |
| (5b) | Acetylene glycol (HLB: 17.1) | — | — | — |

| | | | |
|---|---|---|---|
| Water | 11.3 | 1.1 | 6.6 |
| Total (% by mass) | 100.0 | 100.0 | 100.0 |
| Urethane resin emulsion amount (solid fraction amount) | 4.0 | 8.0 | 5.0 |
| (% by mass) | | | |
| Polyether-type aliphatic urethane resin emulsion amount | 4.0 | 8.0 | 5.0 |
| (solid fraction amount) (% by mass) | | | |
| Acrylic-based resin emulsion amount (solid fraction | 2.0 | 1.0 | 3.0 |
| amount) (% by mass) | | | |
| Resin emulsion total amount (solid fraction amount) | 6.0 | 9.0 | 8.0 |
| (% by mass) | | | |
| Amount of surfactant having HLB of not more than 10.0 | 1.0 | 1.0 | 2.0 |
| (% by mass) | | | |
| Swelling ratio of urethane-based resin emulsion (%) | 30.0 | 30.0 | 45.0 |

TABLE 7
Formulations of Maintenance Liquids

| | | Maintenance Liquid No. | | | | | |
|---|---|---|---|---|---|---|---|
| Unit: % by mass | | 1 | 2 | 3 | 4 | 5 | 6 |
| Water | Glycerol | 35.0 | 30.0 | 35.0 | 30.0 | 20.0 | 30.0 |
| soluble | Triethylene glycol | 10.0 | 3.0 | 10.0 | 10.0 | — | 5.0 |
| organic | Diethylene glycol | — | — | — | — | 5.0 | — |
| solvent | monoethyl ether | | | | | | |
| | Triethylene glycol | 10.0 | 20.0 | 10.0 | 10.0 | — | — |
| | monobutyl ether | | | | | | |
| Surfactant | acetylene glycol | 1.0 | — | — | — | — | — |
| (5a) | (HLB: 4.0) | | | | | | |
| | acetylene glycol | — | 3.0 | 0.5 | 1.0 | — | — |
| | (HLB: 8.1) | | | | | | |
| Surfactant | acetylene glycol | — | — | — | — | 1.0 | — |
| (5b) | (HLB: 13.2) | | | | | | |
| | acetylene glycol | — | — | — | — | — | 1.0 |
| | (HLB: 17.1) | | | | | | |
| Preserva- | PROXEL XL2 (s) | 0.1 | 0.1 | 0.1 | 0.1 | 0.1 | 0.1 |
| tive | | | | | | | |

| | | | | | | |
|---|---|---|---|---|---|---|
| Water | 43.9 | 43.9 | 44.4 | 48.9 | 73.9 | 63.9 |
| Total (% by mass) | 100.0 | 100.0 | 100.0 | 100.0 | 100.0 | 100.0 |
| Amount of surfactant | 1.0 | 3.0 | 0.5 | 1.0 | 0.0 | 0.0 |
| having HLB of not more | | | | | | |
| than 10.0 (% by mass) | | | | | | |
| pH | 9 | 9 | 9 | 9 | 7 | 9 |

TABLE 8
Evaluation Results

| | | Ex- | Ex- | Ex- | Ex- | Ex- | Ex- |
|---|---|---|---|---|---|---|---|
| | | ample | ample | ample | ample | ample | ample |
| | | B1 | B2 | B3 | B4 | B5 | B6 |
| Ink No. | | B1 | B2 | B1 | B1 | B2 | B3 |
| Maintenance Liquid No. | | 4 | 2 | 3 | 1 | 5 | 6 |
| Evaluation | Durability of | AA | AA | AA | AA | AA | AA |
| | printed image | | | | | | |
| | Workability of | A | A | A | A | A | A |
| | printed image | | | | | | |
| | Image quality of | A | A | A | A | A | A |
| | printed image | | | | | | |
| | Uniformity of | A | A | A | A | B | B |
| | printed image | | | | | | |
| | Continuous | AA | AA | AA | A | B | C |
| | jetting | | | | | | |
| | performance | | | | | | |

As shown in the tables, the decorative article of each example exhibited excellent durability and workability of the printed image, and also exhibited excellent image quality of the printed image. Further, the examples exhibited favorable results in the evaluation of the uniformity of the printed image and the evaluation of the continuous jetting performance, by the printing performed after the treatment with the maintenance liquid of each of the examples.

In each of Examples B1 to B6, ink B1, B2 or B3 was used, and each of Examples B1 to B6 exhibited favorable results in the durability, the workability, and the image quality of the printed images.

In each of Examples B1 to B3, the HLB value of the surfactant contained in the maintenance liquid was 8.1, and each of Examples B1 to B3 exhibited favorable results in the uniformity of the printed image and the continuous jetting performance. In each of Examples B1 to B3, the ink and the maintenance liquid contained the same surfactant, and thus, each of Examples B1 to B3 exhibited further improved continuous jetting performance.

In Example B4, the HLB value of the surfactant contained in the maintenance liquid was 4.0, and this Example exhibited favorable results in the uniformity of the printed image and the continuous jetting performance.

In Example B5, the HLB value of the surfactant contained in the maintenance liquid was 13.2, and the uniformity of the printed image and the continuous jetting performance were lowered.

In Example B6, the HLB value of the surfactant contained in the maintenance liquid was 17.1, and the uniformity of the printed image and the continuous jetting performance of the printed image were lowered.

Based on the results of Examples B1 to B6, it is thought that when the HLB value of the surfactant contained in the maintenance liquid is not more than 10.0, the ink adhering to the nozzle surface of the nozzle head can be appropriately removed, and the uniformity of the printed image and the continuous jetting performance are improved.

It is to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. An aqueous inkjet ink comprising:
a water-dispersible polyether-type aliphatic urethane-based resin (A),
a water-dispersible (meth)acrylic-based resin (B),
a surfactant containing an acetylene glycol-based surfactant (C) having an HLB value of not more than 10.0,
a colorant, and
water.

2. The aqueous inkjet ink according to claim 1, wherein when a test piece that is a dried film formed from the water-dispersible polyether-type aliphatic urethane-based resin (A) is immersed in the surfactant of the aqueous inkjet ink, and is taken out from the surfactant after 12 hours, a swelling ratio by mass of the water-dispersible polyether-type aliphatic urethane-based resin (A), expressed as a swelling ratio by mass of the test piece after the immersion relative to a mass of the test piece before the immersion, is within a range from 10 to 100%.

3. The aqueous inkjet ink according to claim 1, wherein an amount of the water-dispersible polyether-type aliphatic urethane-based resin (A) is at least 3.0% by mass relative to a total mass of the ink.

4. The aqueous inkjet ink according to claim 2, wherein an amount of the water-dispersible polyether-type aliphatic urethane-based resin (A) is at least 3.0% by mass relative to a total mass of the ink.

5. An ink set comprising:
The aqueous inkjet ink according to claim 1, and
a maintenance liquid containing:
an acetylene glycol-based surfactant (C′) having an HLB value of not more than 10.0, and
at least 30% by mass, relative to a total mass of the maintenance liquid, of glycerol.

6. The ink set according to claim 5, wherein an amount of water in the maintenance liquid is within a range from 40 to 60% by mass relative to the total mass of the maintenance liquid.

7. The ink set according to claim 5, wherein the acetylene glycol-based surfactant (C) contained in the aqueous inkjet ink, and the acetylene glycol-based surfactant (C′) contained in the maintenance liquid contain the same component.

8. The ink set according to claim 5, wherein when a test piece that is a dried film formed from the water-dispersible polyether-type aliphatic urethane-based resin (A) is immersed in the surfactant of the aqueous inkjet ink, and is taken out from the surfactant after 12 hours, a swelling ratio by mass of the water-dispersible polyether-type aliphatic urethane-based resin (A), expressed as a swelling ratio by mass of the test piece after the immersion relative to a mass of the test piece before the immersion, is within a range from 10 to 100%.

9. The ink set according to claim 5, wherein an amount of the water-dispersible polyether-type aliphatic urethane-based resin (A) is at least 3.0% by mass relative to a total mass of the ink.
